(19) United States
(12) Patent Application Publication
(10) Pub. No.: US 2015/0269606 A1
(43) Pub. Date: Sep. 24, 2015

(54) MULTI-SOURCE PERFORMANCE AND EXPOSURE FOR ANALYTICS

(71) Applicant: DataSphere Technologies, Inc., Bellevue, WA (US)

(72) Inventors: Delane Robert Hewett, Bellevue, WA (US); Christopher Robert Coffman, Seattle, WA (US); Satbir Singh Khanuja, Issaquah, WA (US); Joyce Reyes Farrell, Redmond, WA (US); Erik Olson, Seattle, WA (US); Dustin Roman Brownell, North Bend, WA (US); Laurent Chavet, Kirkland, WA (US); Pradeep Kumar Gupta, Kirkland, WA (US); Chong I. Ka, Bellevue, WA (US); Gary Duncan Cowan, Issaquah, WA (US)

(73) Assignee: DataSphere Technologies, Inc., Bellevue, WA (US)

(21) Appl. No.: 14/223,663

(22) Filed: Mar. 24, 2014

(51) Int. Cl. G06Q 30/02

(52) U.S. Cl. CPC G06Q 30/0243

(57) ABSTRACT

Embodiments are directed to managing content over a network. A plurality of events that may be associated with event sources may be determined. Action information may be generated based on classification of events to action events, such that the events may correspond to a campaign for a merchant. Classifying the events may also include, determining an action type that may correspond to each event based in part on an event source that corresponds to the events.

Performance information may be generated based on the action information. Comparison information may be generated based on at least other performance information that may correspond to other campaigns that may be associated with other merchants. Recommendation information may be generated based on the performance information and the comparison information. Report information may be generated for display to a user based on the performance information and the recommendation information.

### TECHNICAL FIELD

The present invention relates generally to content management, and more particularly to, generating content performance information that is relevant to merchants and businesses.

### BACKGROUND

Today, most businesses rely on some form of mobile or internet based promotions to entice customers to purchase products, access websites, or visit physical facilities, such as a retail stores or showrooms. These promotions generally include online advertisements that inform a consumer about a product and may include coupons, videos, or the like. A large regional or national business can easily afford to research and create customized promotions directed to very large audiences of consumers. However, many small businesses do not have the financial resources to engage in large scale promotions. Also, in many cases, small businesses may be seeking consumers from one or more local regions or neighborhoods. Accordingly, a large area promotion campaign may not be very cost effective for some small businesses because the campaign may cover a larger geographic region than is advantageous. Further, small businesses may be unable to devote the resources that may be necessary for analyzing the effectiveness of the campaigns. Therefore, it may be difficult for small businesses to evaluate and/or improve the performance of their campaigns. Thus, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of an environment in which at least one of the various embodiments may be implemented;

FIG. 2 shows an embodiment of a client computer that may be included in a system such as that shown in FIG. 1;

FIG. 3 shows an embodiment of a network computer that may be included in a system such as that shown in FIG. 1;

FIG. 4 illustrates a logical architecture of a system for multi-source performance and exposure for analytics in accordance with at least one of the various embodiments;

FIG. 5 represents a logical architecture for a system for multi-source performance and exposure for analytics in accordance with at least one of the various embodiments;

FIG. 6 illustrates an overview flowchart for a process for multi-source performance and exposure for analytics in accordance with at least one of the various embodiments;

FIG. 7 illustrates a flowchart for a process for determining actions and/or views from events associated with one or more event sources in accordance with at least one of the various embodiments;

FIG. 8 illustrates a flowchart for a process for generating performance information for a merchant's campaign in accordance with at least one of the various embodiments;

FIG. 9 illustrates a flowchart for a process for determining historical performance history for merchant campaigns in accordance with at least one of the various embodiments;

FIG. 10 illustrates a flowchart for a process for determining comparison performance history for merchant campaigns in accordance with at least one of the various embodiments;

FIG. 11 shows a user interface for displaying an overview of the performance and exposure for the merchant's campaign in accordance with at least one of the various embodiments;

FIG. 12 shows a user interface for displaying information about the actions for a campaign in accordance with at least one the various embodiments;

FIG. 13 shows a user interface for displaying an activity feed that displays performance activity associated with the merchant and/or merchant campaigns in accordance with at least one of the various embodiments; and

FIG. 14 shows a user interface for displaying one or more administrative reports for multi-source performance and exposure for analytics in accordance with at least one of the various embodiments.

### DETAILED DESCRIPTION OF THE EMBODIMENTS

Various embodiments now will be described more fully hereinafter with reference to the accompanying drawings, which form a part hereof, and which show, by way of illustration, specific embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media, or devices. Accordingly, the various embodiments may take the form of an entirely hardware embodiment, an entirely software embodiment, or an embodiment combining software and hardware aspects. The following detailed description is, therefore, not to be taken in a limiting sense.

Throughout the specification and claims, the following terms take the meanings explicitly associated herein, unless the context clearly dictates otherwise. The term “herein” refers to the specification, claims, and drawings associated with the current application. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “widget controller” refers to a computer program that may be operative on a client application. Widget controllers may be downloaded and/or otherwise deployed to a client application. Widget controllers may be arranged to be operative for downloading content, monitoring consumer actions, or otherwise managing widgets located within client applications.

As used herein, the term “widget” refers to a user-interface element located in the client application. Widgets may be invisible or visible to users of the client applications. In some cases, a widget controller may generate widget “on-the-fly” before deploying content into the widget. Widgets may be adapted to reflect the operating environment of the client application that they are being hosted within. For example, in clients that support HTML, CSS a widget may be an HTML element such as a DIV, P, or the like. For client application operative in a Java environment, a widget may be a View object or Window object, and so on.

As used herein, the terms “hyper-local region,” and “hyper local region” refer to a geographic region (area) that is generally smaller than a metropolitan area. A common characteristic of hyper-local regions may be that they are not readily discernible using standard location techniques, such as, Internet Protocol (IP) Addresses, Postal codes, or the like. For example, hyper-local regions may be neighborhoods in cities that may represent regions that may or may not be recognized by an official government body. Also, one or more neighborhoods may be associated with a single hyper-local region. In at least one of the various embodiments, merchants or consumers may be associated with one or more hyper-local regions.

As used herein, the terms “customer, ”, “entity,” or “merchant” may refer to an entity such as, individual person, partnership, organization, corporation, non-profit, governmental organization, municipality, association, club, or the like that operates as a separately identifiable entity that direct and/or participate in promotional campaigns. In at least one of the various embodiments, the entities may contract to have content generated and/or displayed on one or more Host digital media properties (e.g., websites, mobile applications, or the like). Entities may offer, sell or provide products or services to consumers through websites or via physical facilities such as a retail stores, showrooms, warehouses, offices, restaurants, offices, community centers, municipal offices, mobile coverage regions, or the like. In at least one of various embodiments, an entity may also be referred to as a customer, retailer, vendor, professional, product provider, user of the content management application, service provider, merchant, or the like. In this description, for clarity and consistency with one or more of the non-limiting examples, the term merchant is often used in place of the term entity. However, the claimed innovations are not limited to entities that may commonly be considered to be merchants.

As used herein, the term “Host” may refer to an individual person, partnership, organization, or corporate entity that may own or operate one or more digital media properties (e.g., web sites, mobile applications, or the like). Hosts may arrange digital media properties to use hyper-local targeting by arranging the property to integrate with widget controllers, content management servers, or content delivery servers.

As used herein, the term “consumer” may refer to an individual person, partnership, organization, or corporate entity that may purchase, license, lease, or otherwise obtain one or more products from a customer or merchant, where the consumer and the customer are different and separately identifiable. Consumers are those entities that visit the client applications associated with a Host's digital media properties. The content management servers and/or content delivery servers may enable consumers to view and/or interact with content presented on one or most Host digital media properties.

As used herein, the term “offering” may refer to a product, good and/or service that a customer or merchant offers and/or otherwise may make available to consumers. In some cases, the offering may require payment immediately for redemption at time of use or payment for the good/service may be at the time of service/product use.

As used herein, the term “coupon” may refer to a type of content that entitles the holder (e.g., a consumer) of the coupon to redeem a discount on and/or obtain a free product offered by a merchant. In some embodiments, a coupon may be related to a particular product and/or a type of product offered by the merchant. For example, coupons may include, but are not limited to, “Buy 1 Get 1 Free,” “Free Beverage with $5 purchase,” “Free 1 hour consultation,” “$20 off purchase,” “30% off a $100 purchase,” or the like. In at least one embodiment, products that are relatively less expensive, such as food, may be associated with a coupon that offers the product for free. Also, other products that are relatively more expensive, such as professional services, may be associated with coupons that offer the product at a discount. Coupons may be considered a promotional activity that may be part of a promotional campaign.

As used herein, the term “content” may refer to any information and/or data that can be provided to a consumer including textual, graphical, and/or audio content, as well as computer programs. Content may include online content, web pages, videos, images, animation, graphics, illustrations, audio files, text, text messages, emails, documents, posters, flyers, letters, or the like which can be used in product promotions for advertisements, product information, customer information, coupons, or the like. Also, in at least one of the various embodiments, content may also include computer programs, source code, executables, scripts, or the like, or combination thereof.

As used herein, the term “category” may refer to a classification of a customer and/or content. Example categories include, but are not limited to “Health and Beauty,” “Automotive,” “Travel,” or the like. Categories may also be referred to in some embodiments as business categories. Also, in at least one of the various embodiments, consumers, customers, merchants, and content may be classified into one or more categories.

As used herein, the terms “actions” and/or “monitored actions” may refer to a behavior or act being performed on and/or with content, including content displayed in a widget and/or included in a promotional campaign. Actions may include online and/or offline behaviors, such as clicking on content, redeeming a coupon, or the like. In some embodiments, actions may be performed by a consumer on published content (e.g., videos, banners, coupons, or the like). These actions may include, but are not limited to searching, viewing, mousing over, scrolling, selecting, reading, clicking on, printing, sharing, redeeming, or the like. In other embodiments, actions may be performed by a customer on content, such as, but not limited to, modifying a content template and/or other content provided in an advertisement template. Action events may be events corresponding to actions.

As used herein, the term “views” may refer to a behavior or event that may result in a consumer being exposed to particular pieces of content. In some contexts, views may be referred to as impressions. View events may be events that may correspond to views.

As used herein, the terms “merchant campaign,” “promotional campaign,” or “campaign” may refer to one or more coordinated promotional activities conducted by or on behalf of an entity, such as, a merchant. Campaigns may include one or more promotional activities, including different types of advertisements, such as, coupons, banner advertisements, email mailing, promotional videos, or the like. In some case, campaigns may be organized to last for a predefined period of time (e.g., 3 months) in other cases, they may be ongoing indefinitely. Organizing promotional activities into campaigns enables merchants to compare the performance of different promotional strategies by comparing the performance of campaigns. Thus, in at least one of the various embodiments, actions, views, performance reports, performance information, comparison information, historical information, or the like, may be arranged to correspond to particular campaigns for an entity.

As used herein, the term “historical information” refers to past information associated with a merchant or entity. Historical information may include information associated with the configuration and implementation information of past campaigns. For example, in at least one of the various embodiments, historical information may include records of the coupons, advertisements, videos, or the like, that may have been used in the past by the merchant. Historical information may include action information, view information, performance information, or the like, previously associated with a merchant. Historical information may be associated with one or more campaigns for the same merchant. Further, merchant may be enabled to access historical information because it is associated with their campaigns.

As used herein, the term “comparison information” refers to information associated with merchants other than the merchant that is being analyzed. Alternatively, “comparison information” may be aggregated information from multiple merchants including the merchant being analyzed. Comparison information may include information associated with the configuration and implementation information of current and/or past campaigns for other merchants. For example, in at least one of the various embodiments, comparison information may include records of the coupons, advertisements, videos, or the like, that may have been used in the past by other merchants. Accordingly, comparison information may include action information, view information, performance information, or the like, associated with other merchants. A merchant may be able to compare their performance records and/or comparison information with other merchant's comparison information. Further, merchants may be disabled from directly accessing comparison information for specific merchants, instead only seeing comparative information with the other merchant's identity(s) withheld.

The following briefly describes embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments are directed to managing content over a network. In at least one of the various embodiments, a plurality of events that may be associated with a plurality of event sources may be determined. In at least one of the various embodiments, action information may be generated based on at least classification of at least one event of the plurality of events to at least one action event, such that the at least one event may correspond to at least one campaign for at least one merchant. In at least one of the various embodiments, classifying the at least one event, may also include, determining an action type that may correspond to the at least one event based in part on an event source, such that event source corresponds to the at least one event.

In at least one of the various embodiments, performance information may be generated based on at least a portion of the action information. In at least one of the various embodiments, comparison information may be generated based on at least other performance information, such that the at least other performance information may correspond to at least one other campaign that may be associated with at least one other merchant. In at least one of the various embodiments, recommendation information may be generated based on at least a portion of the performance information and at least a portion of the comparison information. In at least one of the various embodiments, report information may be generated for display to a user (merchant) based on at least the portion of the performance information and the recommendation information.

In at least one of the various embodiments, historical information may be generated based on previously generated performance information that may correspond to the at least one campaign and the at least one merchant. In at least one of the various embodiments, the performance information may be modified based on at least one weighting factor. In at least one of the various embodiments, view information may be determined based on classifying at least one other event of the plurality of events to at least one view event, such that the at least one event may correspond to at least one campaign for at least one merchant.

In at least one of the various embodiments, score information may be determined for the at least one campaign based on the at least portion of the performance information, such that the score information may include at least a single value that may represent a number of action events that may correspond to the at least one campaign. Further, in at least one of the various embodiments, an activity feed may be generated for displaying performance information that corresponds to the at least one campaign. In at least one of the various embodiments, other report information that includes performance information from a plurality of campaigns for a plurality of merchants may also be generated and presented to merchant.

### Illustrative Operating Environment

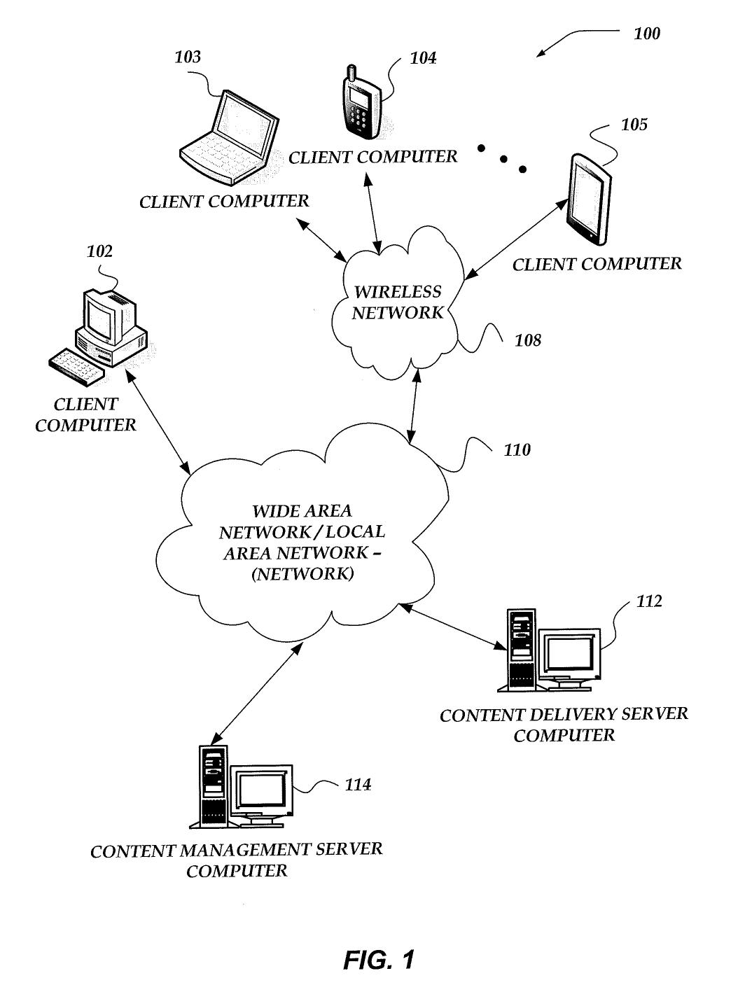

FIG. 1 shows components of one embodiment of an environment in which embodiments of the innovations described herein may be practiced. Not all of the components may be required to practice the innovations, and variations in the arrangement and type of the components may be made without departing from the spirit or scope of the innovations. As shown, system 100 of FIG. 1 includes local area networks (LANs)/wide area networks (WANs)-(network) 110, wireless network 108, client computers 102-105, Content Delivery Server Computer (CDSC) 112, and Content Management Server Computer (CMSC) 114.

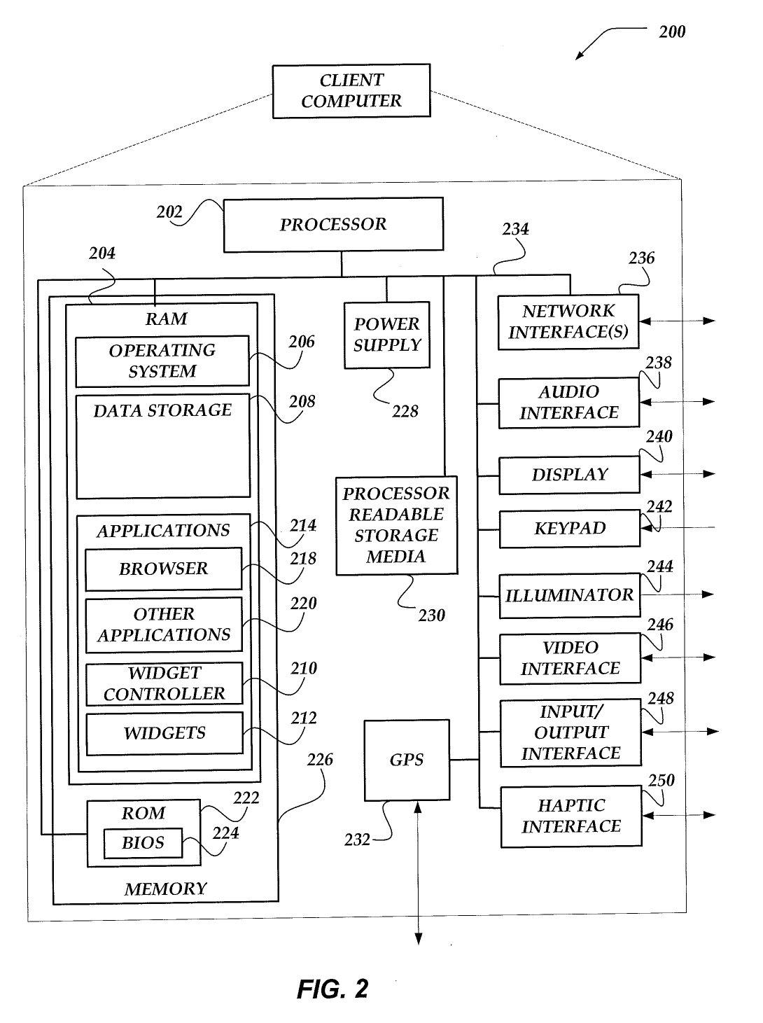

At least one embodiment of client computers 102-105 is described in more detail below in conjunction with FIG. 2. In one embodiment, at least some of client computers 102-105 may operate over a wired and/or wireless network, such as networks 110 and/or 108. Generally, client computers 102-105 may include virtually any computer capable of communicating over a network to send and receive information, perform various online activities, offline actions, or the like. In one embodiment, one or more of client computers 102-105 may be configured to operate within a business or other entity to perform a variety of services for the business or other entity. For example, client computers 102-105 may be configured to operate as a web server, an accounting server, a production server, an inventory server, or the like. However, client computers 102-105 are not constrained to these services and may also be employed, for example, as an end-user computing node, in other embodiments. It should be recognized that more or less client computers may be included within a system such as described herein, and embodiments are therefore not constrained by the number or type of client computers employed.

Computers that may operate as client computer 102 may include computers that typically connect using a wired or wireless communications medium such as personal computers, multiprocessor systems, microprocessor-based or programmable electronic devices, network PCs, or the like. In some embodiments, client computers 102-105 may include virtually any portable personal computer capable of connecting to another computing device and receiving information such as, laptop computer 103, smart mobile telephone 104, and tablet computers 105, and the like. However, portable computers are not so limited and may also include other portable devices such as cellular telephones, display pagers, radio frequency (RF) devices, infrared (IR) devices, Personal Digital Assistants (PDAs), handheld computers, wearable computers, integrated devices combining one or more of the preceding devices, and the like. As such, client computers 102-105 typically range widely in terms of capabilities and features. Moreover, client computers 102-105 may access various computing applications, including a browser, or other web-based application.

A web-enabled client computer may include a browser application that is configured to receive and to send web pages, web-based messages, and the like. The browser application may be configured to receive and display graphics, text, multimedia, and the like, employing virtually any web-based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), and the like, to display and send a message. In one embodiment, a user of the client computer may employ the browser application to perform various activities over a network (online). However, another application may also be used to perform various online activities.

Client computers 102-105 may also include at least one other client application that is configured to receive and/or send content between another computer. The client application may include a capability to send and/or receive content, or the like. The client application may further provide information that identifies itself, including a type, capability, name, and the like. In one embodiment, client computers 102-105 may uniquely identify themselves through any of a variety of mechanisms, including an Internet Protocol (IP) address, a phone number, Mobile Identification Number (MIN), an electronic serial number (ESN), or other device identifier. Such information may be provided in a network packet, or the like, sent between other client computers, Content Delivery Server Computer 112, Content Management Server Computer 114, or other computers.

Client computers 102-105 may further be configured to include a client application that enables an end-user to log into an end-user account that may be managed by another computer, such as Content Delivery Server Computer 112, Content Management Server Computer 114, or the like. Such end-user account, in one non-limiting example, may be configured to enable the end-user to manage one or more online activities, including in one non-limiting example, search activities, social networking activities, browse various websites, communicate with other users, or the like. However, participation in such online activities may also be performed without logging into the end-user account.

Wireless network 108 is configured to couple client computers 103-105 and its components with network 110. Wireless network 108 may include any of a variety of wireless sub-networks that may further overlay stand-alone ad-hoc networks, and the like, to provide an infrastructure-oriented connection for client computers 103-105. Such sub-networks may include mesh networks, Wireless LAN (WLAN) networks, cellular networks, and the like. In one embodiment, the system may include more than one wireless network.

Wireless network 108 may further include an autonomous system of terminals, gateways, routers, and the like connected by wireless radio links, and the like. These connectors may be configured to move freely and randomly and organize themselves arbitrarily, such that the topology of wireless network 108 may change rapidly.

Wireless network 108 may further employ a plurality of access technologies including 2nd (2G), 3rd (3G), 4th (4G) 5th (5G) generation radio access for cellular systems, WLAN, Wireless Router (WR) mesh, and the like. Access technologies such as 2G, 3G, 4G, 5G, and future access networks may enable wide area coverage for mobile devices, such as client computers 103-105 with various degrees of mobility. In one non-limiting example, wireless network 108 may enable a radio connection through a radio network access such as Global System for Mobil communication (GSM), General Packet Radio Services (GPRS), Enhanced Data GSM Environment (EDGE), code division multiple access (CDMA), time division multiple access (TDMA), Wideband Code Division Multiple Access (WCDMA), High Speed Downlink Packet Access (HSDPA), Long Term Evolution (LTE), and the like. In essence, wireless network 108 may include virtually any wireless communication mechanism by which information may travel between client computers 103-105 and another computer, network, and the like.

Network 110 is configured to couple network computers with other computers and/or computing devices, including, Content Delivery Server Computer 112, Content Management Server Computer 114, client computer 102, and client computers 103-105 through wireless network 108. Network 110 is enabled to employ any form of computer readable media for communicating information from one electronic device to another. Also, network 110 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, and/or other carrier mechanisms including, for example, E-carriers, Integrated Services Digital Networks (ISDNs), Digital Subscriber Lines (DSLs), wireless links including satellite links, or other communications links known to those skilled in the art. Moreover, communication links may further employ any of a variety of digital signaling technologies, including without limit, for example, DS-0, DS-1, DS-2, DS-3, DS-4, OC-3, OC-12, OC-48, or the like. Furthermore, remote computers and other related electronic devices could be remotely connected to either LANs or WANs via a modem and temporary telephone link. In one embodiment, network 110 may be configured to transport information of an Internet Protocol (IP). In essence, network 110 includes any communication method by which information may travel between computing devices.

Additionally, communication media typically embodies computer readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media.

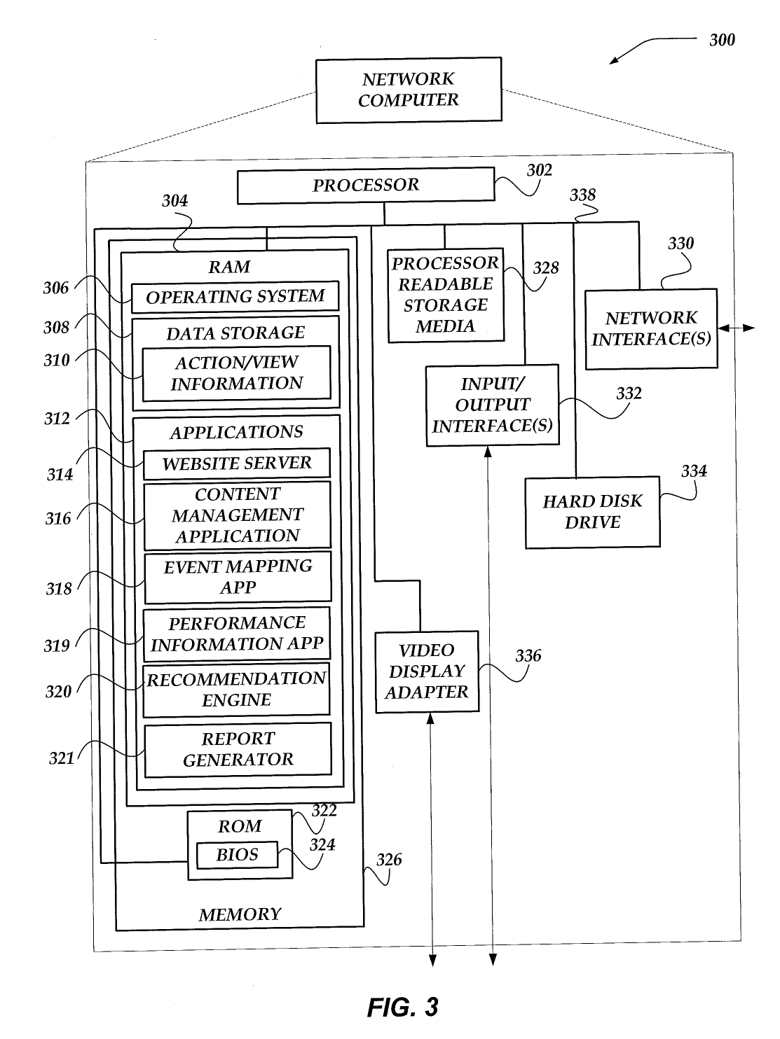

One embodiment of Content Delivery Server Computer 112 is described in more detail below in conjunction with FIG. 3. Briefly, however, Content Delivery Server Computer 112 includes virtually any network computer capable of ranking a plurality of coupons and/or coupon templates for each of a plurality of different categories and recommending a subset of a plurality of coupon templates to a merchant (customer). In at least one embodiment, Content Delivery Server Computer 112 may determine which coupons to recommend to a merchant (customer) based on a plurality of factors, including, but not limited to, a ranked order of the plurality of coupon templates, a category of the merchant (customer), one or more external variables (e.g., a reputation of the merchant (customer), a location of the merchant (customer), or a dollar amount associated with a coupon), or the like. In some embodiments, Content Delivery Server Computer 112 may enable a clients computers to download widget controllers and widgets for display of static and/or interactive content, such as, video, audio, news, events, coupons, advertising, or the like, or combination thereof. Computers that may be arranged to operate as Content Delivery Server Computer 112 include various network computers, including, but not limited to personal computers, desktop computers, multiprocessor systems, microprocessor-based or programmable consumer electronics, network PCs, server computers, network appliances, and the like.

Although FIG. 1 illustrates Content Delivery Server Computer 112 as a single computer, the invention is not so limited. For example, one or more functions of the Content Delivery Server Computer 112 may be distributed across one or more distinct network computers. Moreover, Content Delivery Server Computer 112 is not limited to a particular configuration. Thus, in one embodiment, Content Delivery Server Computer 112 may contain a plurality of network computers. In another embodiment, Content Delivery Server Computer 112 may contain a plurality of network computers that operate using a master/slave approach, where one of the plurality of network computers of Content Delivery Server Computer 112 is operative to manage and/or otherwise coordinate operations of the other network computers. In other embodiments, the Content Delivery Server Computer 112 may operate as a plurality of network computers arranged in a cluster architecture, a peer-to-peer architecture, and/or even within a cloud architecture. Thus, the invention is not to be construed as being limited to a single environment, and other configurations, and architectures are also envisaged.

One embodiment of Content Management Server Computer 114 is described in more detail below in conjunction with FIG. 3. Briefly, however, Content Management Server Computer 114 includes virtually any network computer capable of monitoring actions and/or views associated with campaign content. In some embodiments, the content may be published by Content Delivery Server Computer 112, Content Management Server Computer 114, or another network computer (e.g., a web server) (not shown). Content Management Server Computer 114 may determine statistics regarding the published content. Further, in at least one of the various embodiments, Content Management Server Computer 114 may deliver content, including widget controllers, widgets, audio, video, images, html, news, events, or the like, or combination thereof, to Content Delivery Server Computer 112 for subsequent delivery to clients. Further, Content Management Server Computer may be arranged to collect and analyze action information and/or view information, generate performance information, generate reports, dashboard display information, or the like. Computers that may be arranged to operate as Content Management Server Computer 114 include various network computers, including, but not limited to personal computers, desktop computers, multiprocessor systems, microprocessor-based or programmable consumer electronics, network PCs, server computers, network appliances, and the like.

Although FIG. 1 illustrates Content Management Server Computer 114 as a single computer, the various embodiments are not so limited. For example, one or more functions of the Content Management Server Computer 114 may be distributed across one or more distinct network computers. Moreover, Content Management Server Computer 114 is not limited to a particular configuration. Thus, in one embodiment, Content Management Server Computer 114 may contain a plurality of network computers. In another embodiment, Content Management Server Computer 114 may contain a plurality of network computers that operate using a master/slave approach, where one of the plurality of network computers of Content Management Server Computer 114 operates to manage and/or otherwise coordinate operations of the other network computers. In other embodiments, the Content Management Server Computer 114 may operate as a plurality of network computers within a cluster architecture, a peer-to-peer architecture, and/or even within a cloud architecture. Thus, the invention is not to be construed as being limited to a single environment, and other configurations, and architectures are also envisaged.

Although illustrated separately, Content Delivery Server Computer 112 and Content Management Server Computer 114 may be employed as a single network computer, separate network computers, a cluster of network computers, or the like. In some embodiments, either Content Delivery Server Computer 112 or Content Management Server Computer 114, or both, may be enabled to deliver content, respond to user interactions with the content, track user interaction with the content, update widgets and widgets controllers, or the like.

### Illustrative Client Computer

FIG. 2 shows one embodiment of Client Computer 200 that may be included in a system implementing embodiments of the invention. Client Computer 200 may include many more or less components than those shown in FIG. 2. However, the components shown are sufficient to disclose an illustrative embodiment for practicing the present invention. Client Computer 200 may represent, for example, one embodiment of at least one of Client Computers 102-105 of FIG. 1.

As shown in the figure, Client Computer 200 includes a processor 202 in communication with a mass memory 226 via a bus 234. In some embodiments, processor 202 may include one or more central processing units (CPU). Client Computer 200 also includes a power supply 228, one or more network interfaces 236, an audio interface 238, a display 240, a keypad 242, an illuminator 244, a video interface 246, an input/output interface 248, a haptic interface 250, and a global positioning system (GPS) receiver 232.

Power supply 228 provides power to Client Computer 200. A rechargeable or non-rechargeable battery may be used to provide power. The power may also be provided by an external power source, such as an alternating current (AC) adapter or a powered docking cradle that supplements and/or recharges a battery.

Client Computer 200 may optionally communicate with a base station (not shown), or directly with another computer. Network interface 236 includes circuitry for coupling Client Computer 200 to one or more networks, and is constructed for use with one or more communication protocols and technologies including, but not limited to, GSM, CDMA, TDMA, GPRS, EDGE, WCDMA, HSDPA, LTE, user datagram protocol (UDP), transmission control protocol/Internet protocol (TCP/IP), short message service (SMS), WAP, ultra wide band (UWB), IEEE 802.16 Worldwide Interoperability for Microwave Access (WiMax), session initiated protocol/real-time transport protocol (SIP/RTP), or any of a variety of other wireless communication protocols. Network interface 236 is sometimes known as a transceiver, transceiving device, or network interface card (NIC).

Audio interface 238 is arranged to produce and receive audio signals such as the sound of a human voice. For example, audio interface 238 may be coupled to a speaker and microphone (not shown) to enable telecommunication with others and/or generate an audio acknowledgement for some action.

Display 240 may be a liquid crystal display (LCD), gas plasma, light emitting diode (LED), organic LED, or any other type of display used with a computer. Display 240 may also include a touch sensitive screen arranged to receive input from an object such as a stylus or a digit from a human hand.

Keypad 242 may comprise any input device arranged to receive input from a user. For example, keypad 242 may include a push button numeric dial, or a keyboard. Keypad 242 may also include command buttons that are associated with selecting and sending images.

Illuminator 244 may provide a status indication and/or provide light. Illuminator 244 may remain active for specific periods of time or in response to events. For example, when illuminator 244 is active, it may backlight the buttons on keypad 242 and stay on while the Client Computer is powered. Also, illuminator 244 may backlight these buttons in various patterns when particular actions are performed, such as dialing another client computer. Illuminator 244 may also cause light sources positioned within a transparent or translucent case of the client computer to illuminate in response to actions.

Video interface 246 is arranged to capture video images, such as a still photo, a video segment, an infrared video, or the like. For example, video interface 246 may be coupled to a digital video camera, a web-camera, or the like. Video interface 246 may comprise a lens, an image sensor, and other electronics. Image sensors may include a complementary metal-oxide-semiconductor (CMOS) integrated circuit, charge-coupled device (CCD), or any other integrated circuit for sensing light.

Client computer 200 also comprises input/output interface 248 for communicating with external devices, such as a headset, or other input or output devices not shown in FIG. 2. Input/output interface 248 can utilize one or more communication technologies, such as USB, infrared, Bluetooth™, or the like.

Haptic interface 250 is arranged to provide tactile feedback to a user of the client computer. For example, the haptic interface 250 may be employed to vibrate client computer 200 in a particular way when another user of a computing computer is calling. In some embodiments, haptic interface 250 may be optional.

Client computer 200 may also include GPS transceiver 232 to determine the physical coordinates of client computer 200 on the surface of the Earth. GPS transceiver 232, in some embodiments, may be optional. GPS transceiver 232 typically outputs a location as latitude and longitude values. However, GPS transceiver 232 can also employ other geo-positioning mechanisms, including, but not limited to, triangulation, assisted GPS (AGPS), Enhanced Observed Time Difference (E-OTD), Cell Identifier (CI), Service Area Identifier (SAT), Enhanced Timing Advance (ETA), Base Station Subsystem (BSS), or the like, to further determine the physical location of client computer 200 on the surface of the Earth. It is understood that under different conditions, GPS transceiver 232 can determine a physical location within millimeters for client computer 200; and in other cases, the determined physical location may be less precise, such as within a meter or significantly greater distances. In one embodiment, however, client computer 200 may through other components, provide other information that may be employed to determine a physical location of the computer, including for example, a Media Access Control (MAC) address, IP address, or the like.

Mass memory 226 includes a Random Access Memory (RAM) 204, a Read-only Memory (ROM) 222, and other storage means. Mass memory 226 illustrates an example of computer readable storage media (devices) for storage of information such as computer readable instructions, data structures, program modules or other data. Mass memory 226 stores a basic input/output system (BIOS) 224 for controlling low-level operation of client computer 200. The mass memory also stores an operating system 206 for controlling the operation of client computer 200. It will be appreciated that this component may include a general-purpose operating system such as a version of UNIX, or LINUX™, or a specialized client communication operating system such as Microsoft Corporation's Windows Mobile™, Apple Corporation's iOS™, Google Corporation's Android™ or the Symbian® operating system. The operating system may include, or interface with a Java virtual machine module that enables control of hardware components and/or operating system operations via Java application programs.

Mass memory 226 further includes one or more data storage 208, which can be utilized by client computer 200 to store, among other things, applications 214 and/or other data. For example, data storage 208 may also be employed to store information that describes various capabilities of client computer 200. The information may then be provided to another computer based on any of a variety of events, including being sent as part of a header during a communication, sent upon request, or the like. Data storage 208 may also be employed to store social networking information including address books, buddy lists, aliases, user profile information, or the like. Further, data storage 208 may also store message, we page content, or any of a variety of user generated content. At least a portion of the information may also be stored on another component of client computer 200, including, but not limited to processor readable storage media 230, a disk drive or other computer readable storage devices (not shown) within client computer 200.

Processor readable storage media 230 may include volatile, nonvolatile, removable, and non-removable media implemented in any method or technology for storage of information, such as computer- or processor-readable instructions, data structures, program modules, or other data. Examples of computer readable storage media include RAM, ROM, Electrically Erasable Programmable Read-only Memory (EEPROM), flash memory or other memory technology, Compact Disc Read-only Memory (CD-ROM), digital versatile disks (DVD) or other optical storage, magnetic cassettes, magnetic tape, magnetic disk storage or other magnetic storage devices, or any other physical medium which can be used to store the desired information and which can be accessed by a computer. Processor readable storage media 230 may also be referred to herein as computer readable storage media and/or computer readable storage device.

Applications 214 may include computer executable instructions which, when executed by client computer 200, transmit, receive, and/or otherwise process network data. Network data may include, but is not limited to, messages (e.g. SMS, Multimedia Message Service (MMS), instant message (IM), email, and/or other messages), audio, video, and enable telecommunication with another user of another client computer. Applications 214 may include, for example, browser 218, and other applications 220. Other applications 220 may include, but are not limited to, calendars, search programs, email clients, IM applications, SMS applications, voice over Internet Protocol (VOIP) applications, contact managers, task managers, transcoders, database programs, word processing programs, security applications, spreadsheet programs, games, search programs, and so forth.

Browser 218 may include virtually any application configured to receive and display graphics, text, multimedia, messages, and the like, employing virtually any web based language. In one embodiment, the browser application is enabled to employ HDML, WML, WMLScript, JavaScript, SGML, HTML, XML, and the like, to display and send a message. However, any of a variety of other web-based programming languages may be employed. In one embodiment, browser 218 may enable a user of client computer 200 to communicate with another network computer, such as Content Delivery Server Computer 112 and/or Content Management Server Computer 114 of FIG. 1.

Applications 214 may also include Widget Controller 210 and one or more Widgets 212. Widgets 212 may be collections of content provided to the client computer by Content Delivery Server Computer 112. Widget Controller 210 may be a program that may be provided to the client computer by Content Delivery Server Computer 113. Widget Controller 210 and Widgets 212 may run as native client computer applications or they may run in Browser 218 as web browser based applications. Also, Widget Controller 210 and Widgets 212 may be arranged to run as native applications or web browser applications, or combination thereof.

### Illustrative Network Computer

FIG. 3 shows one embodiment of a network computer 300, according to one embodiment of the invention. Network computer 300 may include many more or less components than those shown. The components shown, however, are sufficient to disclose an illustrative embodiment for practicing the invention. Network computer 300 may be configured to operate as a server, client, peer, a host, or any other computer. Network computer 300 may represent, for example Content Delivery Server Computer 112 and/or Content Management Server Computer 114 of FIG. 1, and/or other network computers.

Network computer 300 includes processor 302, processor readable storage media 328, network interface unit 330, an input/output interface 332, hard disk drive 334, video display adapter 336, and memory 326, all in communication with each other via bus 338. In some embodiments, processor 302 may include one or more central processing units.

As illustrated in FIG. 3, network computer 300 also can communicate with the Internet, or some other communications network, via network interface unit 330, which is constructed for use with various communication protocols including the TCP/IP protocol. Network interface unit 330 is sometimes known as a transceiver, transceiving device, or network interface card (NIC).

Network computer 300 also comprises input/output interface 332 for communicating with external devices, such as a keyboard, or other input or output devices not shown in FIG. 3. Input/output interface 332 can utilize one or more communication technologies, such as USB, infrared, Bluetooth™, or the like.

Memory 326 generally includes RAM 304, ROM 322 and one or more permanent mass storage devices, such as hard disk drive 334, tape drive, optical drive, and/or floppy disk drive. Memory 326 stores operating system 306 for controlling the operation of network computer 300. Any general-purpose operating system may be employed. Basic input/output system (BIOS) 324 is also provided for controlling the low-level operation of network computer 300.

Although illustrated separately, memory 326 may include processor readable storage media 328. Processor readable storage media 328 may be referred to and/or include computer readable media, computer readable storage media, and/or processor readable storage device. Processor readable storage media 328 may include volatile, nonvolatile, removable, and non-removable media implemented in any method or technology for storage of information, such as computer readable instructions, data structures, program modules, or other data. Examples of processor readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by a computer.

Memory 326 further includes one or more data storage 308, which can be utilized by network computer 300 to store, among other things, applications 314 and/or other data such as content 310. For example, data storage 308 may also be employed to store information that describes various capabilities of network computer 300. The information may then be provided to another computer based on any of a variety of events, including being sent as part of a header during a communication, sent upon request, or the like. Data storage 308 may also be employed to store messages, web page content, or the like. At least a portion of the information may also be stored on another component of network computer 300, including, but not limited to processor readable storage media 328, hard disk drive 334, or other computer readable storage medias (not shown) within client computer 300.

Data storage 308 may include a database, text, spreadsheet, folder, file, or the like, that may be configured to maintain and store user account identifiers, user profiles, email addresses, IM addresses, and/or other network addresses; or the like.

In at least one of the various embodiments, Data storage 308 may include action/view information 310, which may contain information determined from one or more events for one or more merchants. Action/View Information 310 may include historical information for a merchant as well as comparison information based on some or all of the merchants that may be associated with the system.

Data storage 308 may further include program code, data, algorithms, and the like, for use by a processor, such as processor 302 to execute and perform actions. In one embodiment, at least some of data store 308 might also be stored on another component of network computer 300, including, but not limited to processor-readable storage media 328, hard disk drive 334, or the like.

Applications 312 may include computer executable instructions, which may be loaded into mass memory and run on operating system 306. Examples of application programs may include transcoders, schedulers, calendars, database programs, word processing programs, Hypertext Transfer Protocol (HTTP) programs, customizable user interface programs, IPSec applications, encryption programs, security programs, SMS message servers, IM message servers, email servers, account managers, and so forth. Applications 312 may also include website server 314, Content Management Application 316, Event Mapping Application 318, Performance Information Application 319, Recommendation Engine 320, and/or Report Generator 321.

Website server 314 may represents any of a variety of information and services that are configured to provide content, including messages, over a network to another computer. Thus, website server 314 can include, for example, a web server, a File Transfer Protocol (FTP) server, a database server, a content server, or the like. Website server 314 may provide the content including messages over the network using any of a variety of formats including, but not limited to WAP, HDML, WML, SGML, HTML, XML, Compact HTML (cHTML), Extensible HTML (xHTML), or the like.

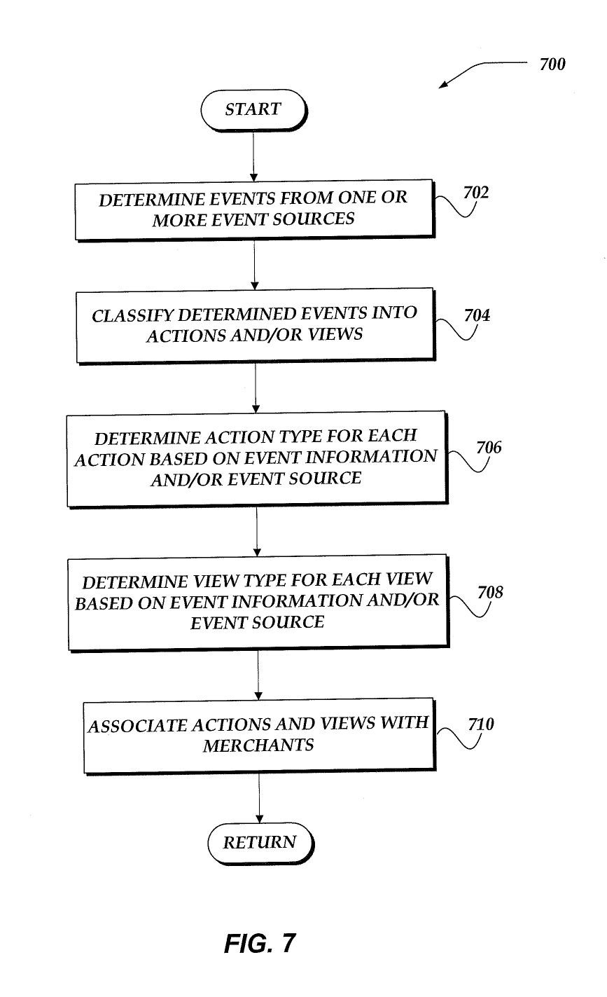

Content Management Application 316 may be configured to generate and/or provide, content (e.g., news, events, audio, video, advertisements, or the like), widget controllers, widgets, or the like, that may be hosted on Content Delivery Server Computer 112, or the like. In at least one of the various embodiments, Content Management Application 316 may be operative on Content Management Server Computer 114 of FIG. 1. In any event, Content Management Application 316 may employ processes, or parts of processes, similar to those described in conjunction with FIGS. 7-15, to perform at least some of its actions.

Event Mapping Application 318 may be arranged and configured to classify and/or map one or more determined events relating content and campaigns that are associated with the merchants. In at least one of the various embodiments, Event Mapping Application 318 may be operative on Content Management Server Computer 114 of FIG. 1. In any event, Event Mapping Application 318 may employ processes, or parts of processes, similar to those described in conjunction with FIGS. 7-15, to perform at least some of its actions.

Performance Information Application 319 may be arranged and configured to determine and/or generate performance information that may be associated with one or more campaigns for one or more merchants. In at least one of the various embodiments, Performance Information Application 319 may be operative on Content Management Server Computer 114 of FIG. 1. In any event, Performance Information Application 319 may employ processes, or parts of processes, similar to those described in conjunction with FIGS. 7-15, to perform at least some of its actions.

Recommendation Engine 320 may be arranged and configured to determine and/or generate recommendations for improving the performance of one or more advertising campaigns for one or more merchants. In at least one of the various embodiments, Recommendation Engine 320 may be operative on Content Management Server Computer 114 of FIG. 1. In any event, Recommendation Engine 320 may employ processes, or parts of processes, similar to those described in conjunction with FIGS. 7-15, to perform at least some of its actions.

Report Generator 321 may be arranged and configured to determine and/or generate reports based on the performance information for one or more advertising campaigns for one or more merchants. In at least one of the various embodiments, Report Generator 321 may be operative on Content Management Server Computer 114 of FIG. 1. In any event, Report Generator 321 may employ processes, or parts of processes, similar to those described in conjunction with FIGS. 7-15, to perform at least some of its actions.

### Illustrative Logical System Architecture

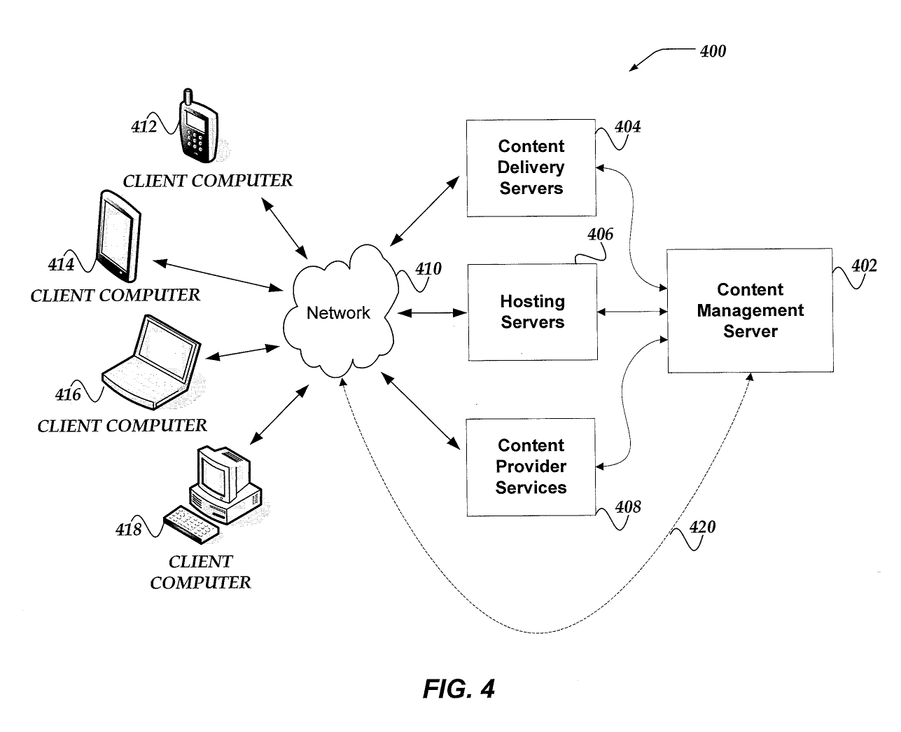

FIG. 4 illustrates a logical architecture of system 400 for multi-source performance and exposure for analytics in accordance with at least one of the various embodiments. In at least one of the various embodiments, Content Management Server 402 may be arranged to be in communication with Content Delivery Servers 404, Hosting Servers 406, Content Provider Services 408, or the like.

In at least one of the various embodiments, Content Management Server 402 may be one or more computers arranged to manage content, such as, Content Management Server Computer 114, or the like. In at least one of the various embodiments, Content Delivery Servers 404 may include one or more computers, such as, Content Delivery Server Computer 112, or the like.

In at least one of the various embodiments, Hosting Servers 406, may include one or more computers, such as, network computer 300, or the like, that host one or more types of content that are provided for consumers and/or merchants. For example, hosting servers 406 may include one or more web servers providing web sites, video hosting sites, images hosting sites, streaming media online stores, or the like. In at least one of the various embodiments, hosting servers may be arranged to integrate with Content Management Server 402.

In at least one of the various embodiments, Content Provider Services 408, may include one or more third-party and/or external content provider services. Content Provider Services 408 may include social network platforms, media distribution platforms, online shopping networks, coupon distribution/syndication web services, or the like. In at least one of the various embodiments, Content Management Server 402 may be arranged to integrate and/or communicate with Content Provider Services 408 using API's or other communication interfaces provided by the services. For example, one content provider service may offer a HTTP/REST based interface that enables Content Management Server 402 to determine various events that may be associated with content provided by the service.

In at least one of the various embodiments, content served from and/or hosted on Content Delivery Servers 404, Hosting Servers 406, Content Provider Services 408 may be provided over network 410 to one or more client computers, such as, Client Computer 412, Client Computer 414, Client Computer 416, Client Computer 418, or the like.

In at least one of the various embodiments, communication between Content Management Server 402 and Content Delivery Servers 404, Hosting Servers 406, Content Provider Services 408 may include one more events that may correspond to one or more actions and/or views. Further, Content Management Server 402 may be arranged to communicate directly or indirectly over network 410 to the client computers using one or more direct network paths, such as network path 420. This communication may include information associated with one or more events occurring on the client computers.

In at least one of the various embodiments, Content Management Server 402 may employ the communications from Content Delivery Servers 404, Hosting Servers 406, Content Provider Services 408, network path 420, or the like, to determine action information and/or view information corresponding to campaigns and/or content comprising campaigns for some or all of the merchants.

One of ordinary skill in the art will appreciate that the architecture of system 400 is a non-limiting example that is illustrative of at least a portion of at least one of the various embodiments. As such, more or less components may be employed and/or arranged differently without departing from the scope of the innovations described herein. However, system 400 is sufficient for disclosing at least the innovations claimed herein.

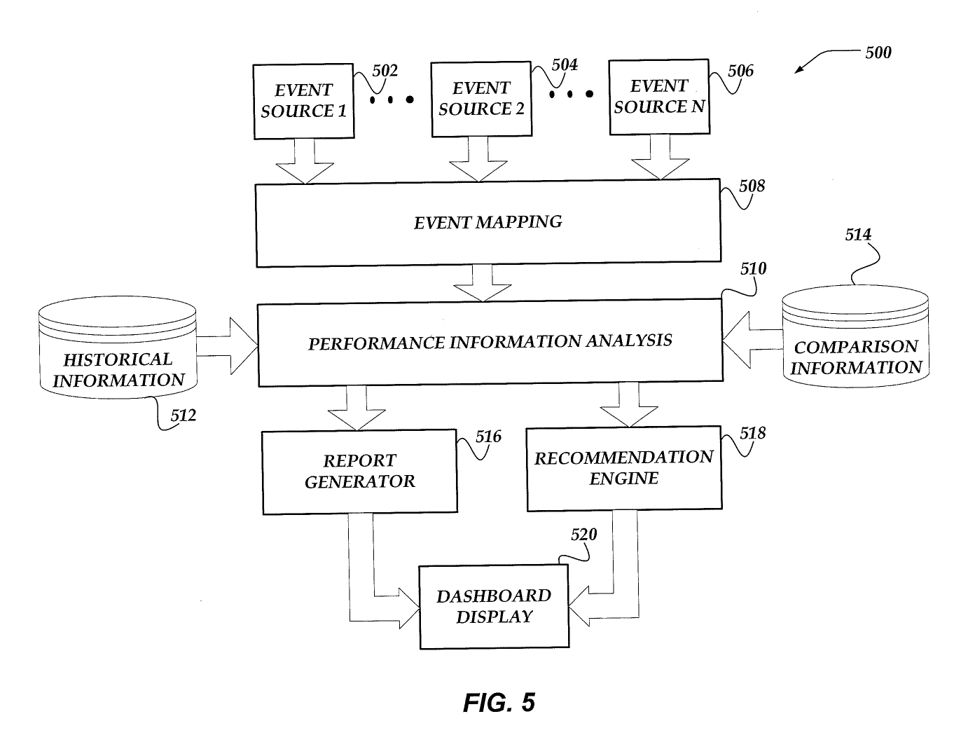

FIG. 5 represents a logical architecture for system 500 for multi-source performance and exposure for analytics in accordance with at least one of the various embodiments. In at least one of the various embodiments, events from one or more event sources, such as, event source 502, event source 504, or event source 506 may be determined. In at least one of the various embodiments, event sources may include Content Delivery Servers 404, Hosting Servers 406, Content Provider Services 408, network path 420, or the like. In at least one of the various embodiments, the determined events may correspond to various user interactions, display operations, impressions, or the like, related to content that may be managed by a content management server, such as, Content Management Server Computer 114, network computer 300, or the like. In at least one of the various embodiments, system 500 may include more or fewer event sources than shown in FIG. 5.

In at least one of the various embodiments, events that may be received and/or determined from one or more events sources may be process in event mapping component 508. In at least one of the various embodiments, given the disparate sources of the determined events they may be defined using dissimilar criteria and/or definitions. Further, in at least one of the various embodiments, the various event sources may provide event information using a variety of data formats and/or communication protocols. Thus, event mapping component 508 may be arranged to map to determined events into one or more actions and/or views. In at least one of the various embodiments, this mapping may normalize events that may be received from disparate event sources.

In at least one of the various embodiments, event mapping component 508 may be arranged to use one or more filters, tests, rules, regular expressions, pattern matches, lookup tables, heuristics, or the like, for mapping the determined events to actions and/or views. In some embodiments, event mapping component 508 may be arranged to determine the particular, filters, tests, rules, regular expressions, pattern matches, lookup tables, heuristics, or the like, for mapping events based on the event source. For example, a content management service computer may be configured to employ a particular set of filters and rules for mapping events from a particular source.

In at least one of the various embodiments, event mapping component 508 may generate one or more actions and/or views based on the determined events. In at least one of the various embodiments, information corresponding to each action and/or view may be stored using well-known data structures such as objects, hashes, arrays, linked lists, or the like. In at least one of the various embodiments, the action information and/or the event information may be stored in a database and associated with at least the merchant that corresponds to the content that is associated with the determined events.

In at least one of the various embodiments, performance information analysis component 510 may be arranged to determine performance information based on the action information and/or view information associated with a merchant. In at least one of the various embodiments, performance information analysis may include determining the number of actions and views associated with one or more campaigns for a merchant.

Also, in at least one of the various embodiments, performance information analysis may include determining historical information from a record store, such as, historical information database 512. In at least one of the various embodiments, historical information database 512 may include action information, view information, performance information, campaign information, or the like, previously associated with a merchant and/or a campaign. Thus, in at least one of the various embodiments, historical information database 512 may be a storehouse of past performance information that is associated with a merchant. In at least one of the various embodiments, historical information may include information associated with the configuration and implementation information of past campaigns. For example, in at least one of the various embodiments, historical information may include records of the coupons, advertisements, videos, or the like, that may have been used in the past by the merchant.

In at least one of the various embodiments, performance analysis may include determining comparison information from a record store, such as, comparison information database 514. In at least one of the various embodiments, comparison information database 514 may include action information, view information, performance information, campaign information, or the like, associated with other merchants in the system. Thus, in at least one of the various embodiments, comparison information database 514 may be a storehouse of performance information that is associated with other merchants. In at least one of the various embodiments, comparison information may include information associated with the configuration and implementation information of current and/or past campaigns for other merchants. For example, in at least one of the various embodiments, comparison information may include records of the coupons, advertisements, videos, or the like, that may have been used by other merchants.

In at least one of the various embodiments, the determined comparison information may be selected from comparison information associated with other merchants that may be somewhat similar to the merchant. For example, in at least one of the various embodiments, if the merchant being analyzed is a bakery, then the comparison information may be determined based on other merchants that may also be bakeries or even a more general, higher-level category such as Food & Dining. In at least one of the various embodiments, one or more criteria may be employed to determine the other merchants, such as, merchant type, location, size of business, or the like.

In at least one of the various embodiments, performance information from performance information analysis component 510 may flow to report generator 516 and/or recommendation engine 518. In at least one of the various embodiments, report generator 516 may be arranged to generate one or more reports based on the performance information. In at least one of the various embodiments, reports may include historical information or comparison information as well as performance information. In at least one of the various embodiments, reports may be determined and formatted based on one or more report templates.

In at least one of the various embodiments, recommendation engine 518 may determine one or more recommendations for improving the performance and/or effectiveness of a merchant advertising campaign. In at least one of the various embodiments, recommendations may be based on performance information, historical information, location information and/or comparison information, or the like. Also, in at least one of the various embodiments, recommendations may be generated based on one or more goals and/or criteria that may be established by the merchant.

In at least one of the various embodiments, dashboard display 520 may render a summary display of the information produced by the other components of the systems. In at least one of the various embodiments, the type of information and/or the level of detail presented on a dashboard display may be determined based in part on the role of the dashboard user. For example, in at least one of the various embodiments, a user that is associated with a merchant may be offered high level summary information that quickly and clearly conveys information that summarizes the performance of the campaign. In contrast, in at least one of the various embodiments, a user that is an administrator of the content management system may be presented a more complex dashboard display. In at least one of the various embodiments, dashboard information may be based on the performance information, report information, recommendation information, historical information, comparison information, or the like, or combination thereof.

In at least one of the various embodiments, dashboard display 520 may be presented on a client computer accessed over network, such as client computers 102, 103, 104, 105, 200, 412, 414, 416, 418, or the like. Also, in at least one of the various embodiments, dashboard display 520 may be presented on a network computer, such as, Content Management Server Computer 114, network compute 300, or the like.

### Generalized Operation

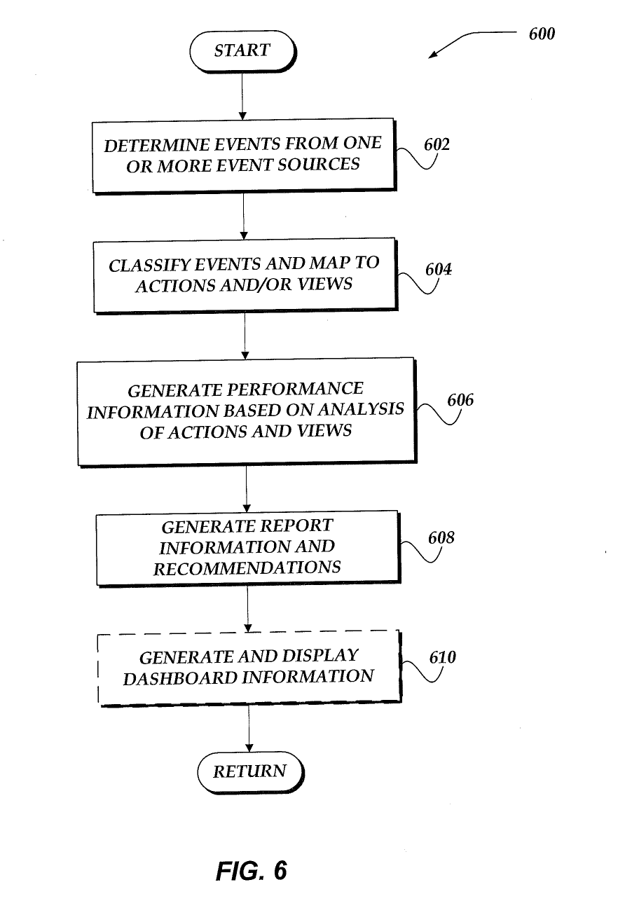

The operation of certain aspects of the invention will now be described with respect to FIGS. 6-10. In at least one of various embodiments, processes 600, 700, 800, 900, and 1000 described in conjunction with FIGS. 6-10, respectively, may be implemented by and/or executed on a single network computer, such as network computer 300 of FIG. 3. In other embodiments, these processes or portions of these processes may be implemented by and/or executed on a plurality of network computers, such as network computer 300 of FIG. 3. Likewise, in at least one of the various embodiments, processes 600, 700, 800, 900, and 1000, or portions thereof, may be operative on one or more client computers, such as client computer 200. However, embodiments are not so limited, and various combinations of network computers, client computers, virtual machines, or the like may be utilized. Further, in at least one of the various embodiments, the processes described in conjunction with FIGS. 6-10 may be operative in system with logical architectures such as those described in conjunction with FIGS. 4-5.

FIG. 6 illustrates an overview flowchart for process 600 for multi-source performance and exposure for analytics in accordance with at least one of the various embodiments. After a start block, at block 602, in at least one of the various embodiments, events may be determined from one or more event sources. In at least one of the various embodiments, event sources may include web servers that may be hosting content associated with merchants; notifications and/or push feeds from various content service providers; server log files, information pulled using API's from one or more content service providers, information provided by on-line and/or off-line coupon distributors; information provided by online consumer review services; or the like.

In at least one of the various embodiments, event information may be stored in one or more data stores, for later processing and/or analysis. Likewise, in at least one of the various embodiments, event information may be processed as it is determined or received. Also, event information may be stored in data stores, such as databases, for use as historical information and/or comparison information.

At block 604, in at least one of the various embodiments, the determined events may be classified and/or map to one or more actions and/or one or more views. See, the description of process 700 in FIG. 7.

At block 606, in at least one of the various embodiments, performance information corresponding to a merchant may be generated based on at least on an analysis of the actions and views that may be determined in block 604. Further, in at least one of the various embodiments, historical information and/or comparison information may also be employed for generating performance information.

At block 608, in at least one of the various embodiments, report information and/or recommendations may be generated based on the performance information.

At block 610, in at least one of the various embodiments, optionally, dashboard information may be generated and/or displayed. The dashboard information may be based on the performance information, report information, recommendation information, historical information, comparison information, or the like, or combination thereof. In at least one of the various embodiments, this block may be optional because process 600 may be arranged and/or configured to generate performance information, report information, or the like, separate from generating the corresponding dashboard information. Next, in at least one of the various embodiments, control may be returned to a calling process.

FIG. 7 illustrates a flowchart for process 700 for determining actions and/or views from events associated with one or more event sources in accordance with at least one of the various embodiments. In at least one of the various embodiments, content management application 316 and/or event mapping application 318 may be arranged and/or configured to perform at least the actions of process 700.

After a start block, at block 702, in at least one of the various embodiments, events from one or more events sources may be determined. In at least one of the various embodiments, event sources may include web servers that may be hosting content associated with merchants; notifications and/or push feeds from various content service providers; server log files, information pulled using API's from one or more content service providers; information provided by on-line and/or off-line coupon distributors; information from online media services (e.g., streaming video sites, photograph sharing sites, online music sharing/selling sites, or the like); information provided by online consumer review services; or the like.

In at least one of the various embodiments, each event may correspond to particular content that may be associated with a merchant and/or a merchant campaign. For example, in at least one of the various embodiments, an event may be generated each time a merchant online/web-site banner advertisement is displayed to a user. Likewise, for example, in at least one of the various embodiments, a separate event may be generated if a user clicks on a merchant online banner advertisement.

In at least one of the various embodiments, an event may be generated each time a user interacts with content associated with a merchant and/or a merchant campaign. In at least one of the various embodiments, the form and frequency of events may depend on the event source. For example, content service providers may stipulate a particular format and/or arrangement for events that it generates. In other cases, events generate by web servers may be in the format of one or more well-known HTTP log formats.

Furthermore, in at least one of the various embodiments, various events source may generate event information that includes different values for the same type of interaction. Also, in at least one of the various embodiments, event sources may generate more or less detail for the same type of interactions. For example, one event source may provide a mouse-down-click event and a mouse-up-click event for a click interaction, whereas, another event source may provide a single click event. In at least one of the various embodiments, a widget deployed on a client computer may generate events that include precise interaction details, such as, click location, click duration, or the like.

In at least one of the various embodiments, multiple events may be bundled in a single communication. For example, a content provider service, such as a coupon distribution service, may bundle some or all events that occur in given time period (e.g., hour, day, week, month, or the like) into a single communication. Further, in some cases, communications from event sources, may bundle events from one or more merchants and/or merchant campaigns.

In at least one of the various embodiments, event information may be stored in one or more data stores, such as, a database, log files, or the like, for later processing and/or analysis. Likewise, in at least one of the various embodiments, event information may be processed as it is determined or received. Also, event information may be stored in data stores, such as databases, for use as historical information and/or comparison information.

At block 704, in at least one of the various embodiments, the determined events may be classified into actions and/or views. In at least one of the various embodiments, as noted above, event sources may provide events using a wide range of formats, styles, or arrangements. Accordingly, in at least one of the various embodiments, process 700 may be arranged to classify and/or categorize the events.

In at least one of the various embodiments, events may be determined to be either actions or views. In at least one of the various embodiments, actions may be events associated with a user and/or consumer performing an intentional interaction with a portion of managed content. Examples of actions may include user interactions such as, clicks, printing, saving, bookmarking, opening, closing, sharing, downloading, blocking, grouping, prioritizing, adding to a list, or the like. In contrast, in at least one of the various embodiments, views may be events associated with one or more passive interaction associated with a user and/or consumer and a portion of managed content. Examples, of views may include user interactions, such as displaying a banner advertisement, displaying a coupon, popup display of content, pop-under display of content, automatically playing audio and/or video media, or the like.

In at least one of the various embodiments, event mapping application 318 may be arranged to employ various techniques for determine if an event is an action or a view. In at least one of the various embodiments, one or more event sources may be known in advance to be limited to generating only one type of event, either exclusively actions, or exclusively views. In these cases, event mapping application 318 may designate each event from such event sources as the either a view or action, depending on a configuration rule and/or designator that may be correspond to the event source.

In at least one of the various embodiments, one or more characteristics of the events may be parsed and/or analyzed to determine if the event may be an action or a view. Also, in at least one of the various embodiments, the content of each event may be parsed and/or processed for determining if the event is an action or a view.

At block 706, in at least one of the various embodiments, an action type for each action may be determined based on event information and/or the event source. In at least one of the various embodiments, if an event has been classified as an action, it may be further classified by assigning it an action type. In at least one of the various embodiments, event mapping application 318 may be arranged to employ one or more rules to classify each action into an action type. In at least one of the various embodiments, the rules employed for classify the actions into types may include one or more programmatic techniques, such as, pattern matching, regular expressions, that may be tailored to correspond the characteristics of the event as provided by the event source.

In at least one of the various embodiments, the classification of actions into types may be aggregated based on mapping the consumer's location to broader locations such as neighborhoods based on location information (e.g., latitude and longitude coordinates) reported by their mobile device or browser.

In at least one of the various embodiments, action types may be organized based on the type of managed content that is associated with the event, such as, coupon actions, banner advertisement actions, video actions, audio actions, chat actions, classified advertisement actions or the like. For each of the actions associated with a type of content, there may be additional action sub-types (still referred to as action types).

For example, in at least one of the various embodiments, coupon action types may include, coupon printing, coupon grouped, coupon click-to-call, coupon share, coupon detail view, coupon mobile activation, coupon click get directions, coupon save, coupon show telephone number, on-location redemption, or the like.

Likewise, in at least one of the various embodiments, video action types may include video playing, video sharing, video downloading, video stopping/aborting, video click-to-call, video detail view, or the like. Note, in at least one of the various embodiments, video action types may be defined to include actions associated with interactions made available in association with video, such as, links, buttons, or the like, presented with (at the same time as) the video/video player.

Also, in at least one of the various embodiments, banner advertisements action types and/or classified advertisement action types may include, clicked, click-to-call, click-to-chat, detail view, or the like.

In at least one of the various embodiments, actions may be chained such that one action may lead to another. Accordingly, actions of different types may be chained together. For example, in at least one of the various embodiments, a coupon detail view action may result in a web page being displayed, where the web page may include other actionable content, such as, other coupons, videos, banner advertisements, one or more contact methods (e.g., click-to-call, click-to-chat, send email/message, or the like), classified advertisements, or the like.

In at least one of the various embodiments, determining if an event is action may occur at the same time action type may be determined. Also, in at least one of the various embodiments, more than one event may be examined to determine an action type. Likewise, in at least one of the various embodiments, more than one action may be included in a single event.

In at least one of the various embodiments, action types may be determined by software that may be arranged to perform pattern matching. In some cases, the software may include pattern matching expressions (e.g., regular expressions) that are tailored to process the expected event format. Accordingly, in at least one of the various embodiments, the event mapping application may be arranged to associate particular pattern matching expressions with particular event sources. For example, in at least one of the various embodiments, the event mapping application may include multiple pattern matching expressions associated with different event sources and the different characteristics of the events produced by each event source.

In at least one of the various embodiments, one or more event sources may share the same pattern matching expressions if they use similar formatting for events. In some cases, generalized and/or shared pattern matching expressions may be employed for rough classification of an action and then more specific pattern matching expressions may be used to further classify the action.

For example, in at least one of the various embodiments, event sources that are web servers may generate events that are HTTP GET request strings that at least include the word “coupon.” Accordingly, in this example, a pattern matching expression, such as, as regular expression that matches the string “coupon” may be employed to determine that an event is a coupon action. However, continuing with this example, it may be the various web server event sources use different methods to further define the coupon action. For example, some web server event sources may include action information such as if the coupon was printed in the query string of the HTTP request, while others event sources may provide such information in the HTTP header values. Accordingly, in this example, as combination of shared pattern matching expressions and pattern matches specific to the event source may be employed to fully classify the events and/or actions.

In at least one of the various embodiments, the event mapping application may determine the pattern matching expression for classifying events and/or actions based on the event source. Accordingly, in at least one of the various embodiments, patterning matching expressions that may be customized for each event source (or each kind of event source) may be defined. IN some cases the pattern matching expression for an event source may be comprised of one or more steps that include different pattern matching expressions linked together with transitional and/or conditional expressions.

At block 708, in at least one of the various embodiments, a view type for each view may be determined based on event information and/or event source. Similar to determined actions types, views and/or view event ma be further classified into view types. In at least one of the various embodiments, view types may include web page view, mobile application view, pop-up view, pop-under view, image view, text-only view, or the like. In at least one of the various embodiments, the event mapping application may be arranged to further classify views using one or more pattern matching expressions, transitional expressions, conditional expressions, or the like, that may be tailored to particular event sources.

At block 710, in at least one of the various embodiments, the actions and views may be associated with the merchants that may correspond to the source of the events. In at least one of the various embodiments, events sources may provide events in various formats having various parameters, or the like. Accordingly, in at least one of the various embodiments, the event mapping application may be arranged to employ one or more pattern matching expressions on the events to identify which merchant and/or merchant campaign to associate with the determined actions and views. For example, in at least one of the various embodiments, each event may include a value or expression that identifies which merchant and/or merchant campaign to associate with the event. However, in at least one of the various embodiments, separate event sources may employ different methods for indicating the identity of the merchant and/or merchant campaign. Accordingly, configuration rules may be arranged to associated pattern matching expressions for extracting merchant identifiers from the events.

Furthermore, in at least one of the various embodiments, the merchant identifier included in the event may be different from the identifier employed by the content management application for identifying the merchant. Thus, in at least one of the various embodiments, the event mapping application may be arranged to employ a lookup table, or the like, to map merchant identifiers extracted from the events to merchant identifiers used by the content management application. Accordingly, in at least one of the various embodiments, the determined merchant identifier may be associated with each action and/or view and stored in a database, or other data store. Next, in at least one of the various embodiments, control may be returned to a calling process.

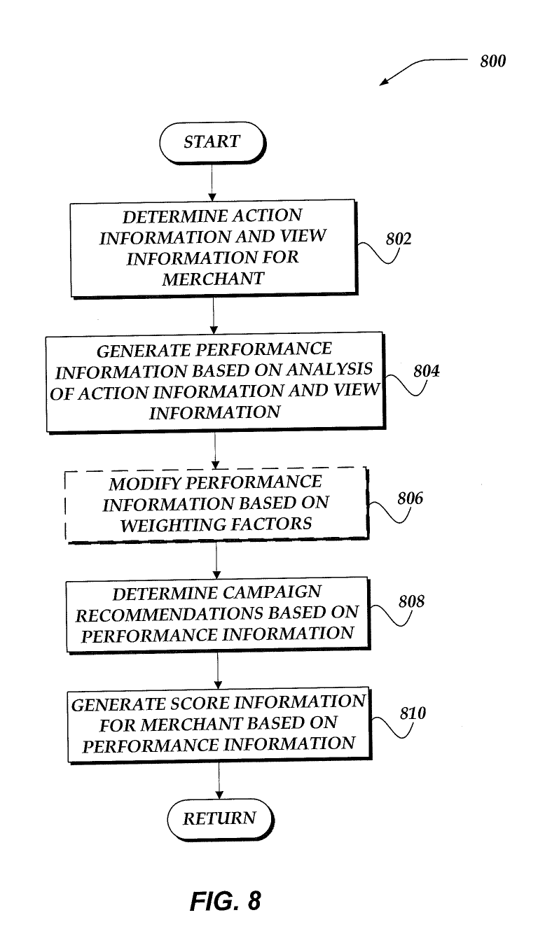

FIG. 8 illustrates a flowchart for process 800 for generating performance information for a merchant's campaign in accordance with at least one of the various embodiments. After a start block, at block 802, in at least one of the various embodiments, action information and view information may be determined for a merchant. In at least one of the various embodiments, the actions comprising the action information and the views comprising the view information may be determined for a merchant. Thus, in at least one of the various embodiments, performance information application 319 may be arranged to execute a database query, or the like, to determine the action information and/or view information for a merchant.

In at least one of the various embodiments, action information and/or view information may also be determined for a campaign rather that for a merchant. Accordingly, in at least one of the various embodiments, merchants having multiple campaigns may be enabled to review and compare one or more separate campaigns.

In at least one of the various embodiments, action information and view infoanation may be determined for a particular time range, such as, an hour, day, week, month, quarter, year, or the like. In at least one of the various embodiments, the length of the time range may be determined based on a configuration value, or it may be based on user input.

At block 804, in at least one of the various embodiments, performance information may be generated based at least on an analysis of the action information and the view information. In at least one of the various embodiments, performance information may comprise counts and/or scores of the various actions and/or views associated with a merchant and/or merchant campaign. In at least one of the various embodiments, performance information may include actions and/or views associated with one or more portions of managed content.

In at least one of the various embodiments, the performance information may be grouped and/or organized based on action types. For example, in at least one of the various embodiments, performance information may be generated such that it includes some or all of the coupon actions. Furthermore, in at least one of the various embodiments, performance information may include a single value representing some or all of the actions associated with the merchant and/or merchant campaign. For example, in at least one of the various embodiments, if action information for a merchant includes 30 coupon clicks, 20 click-to-call action, 10 coupon prints, performance information may be generated to include a actions score of 60 for the time period.

In at least one of the various embodiments, the performance information application may determine historical information that may be associated with the merchant and/or merchant campaign. For example, in at least one of the various embodiments, if performance information is being generated for the current month, the performance information application may determine historical performance information for the previous months for the merchant and/or merchant campaign. In at least one of the various embodiments, the historical performance information may be at least employed to compare the current performance of the campaign to past performance.

Also, in at least one of the various embodiments, the performance information application may determine comparison performance information for the merchant campaign. In at least one of the various embodiments, comparison performance information may be performance information associated with past and/or current performance of other merchants. In at least one of the various embodiments, comparison performance information may be determined based on other merchants that may have one or more similar characteristics to the merchant that is being analyzed. For example, in at least one of the various embodiments, if the merchant currently being processed is a bakery in medium sized market, comparison performance information may comprise performance information that is associated with other bakeries in medium sized markets.

In another example, in at least one of the various embodiments, if the merchant currently being processed is a bakery in a specific neighborhood, zip code, city, Designated Marketing Area (DMA), county, region, or state, comparison performance information may comprise performance information that is associated with other bakeries in the same specific neighborhood, zip code, city, DMA, county, region, or states.

In at least one of the various embodiments, comparison performance information may be employed to compare the performance of the current merchant's campaign with other similarly situated merchants. For example, if a merchant is registering 100 actions per month while comparative merchants are registering 150 actions per month, this information may indicate that there may be one or more modifications available for improving campaign performance.

In at least one of the various embodiments, performance information may be generated based on aggregating the performance information based on one or more considerations, such as, the location of the entity and/or merchant, the location of a consumer, the category of the entity and/or merchant, or the like, or combination thereof.

At block 806, in at least one of the various embodiments, optionally, the performance information may be modified based on one or more weighting factors. In at least one of the various embodiments, some actions and/or views may be more important and/or more relevant than others. For example, in at least one of the various embodiments, a coupon print action may be more important than a coupon click action. Accordingly, the action information that may comprise the performance information may be weighted to account for the relative importance of each action type.

At block 808, in at least one of the various embodiments, campaign recommendations may be determined based on the generated performance information. In at least one of the various embodiments, recommendation engine 320 may be arranged to receive performance information and transform it into one or more recommendations for improving the performance of the merchant campaign.

In at least one of the various embodiments, comparison performance information may be employed to identify potential deficiencies in the current merchant's campaign. Accordingly, if the current merchant is registering a below average number of actions, the recommendation engine may determine one or more better performing campaigns. Differences between the better performing campaign(s) and the current campaign may be determined. For example, it may be that campaigns using online video campaigns register 15% more actions than campaigns that do not employ video. In this example, a recommendation engine may recommend the merchant add a video component to its campaigns. Likewise, for example, the recommendation engine may determine that for a particular class of merchant, two-for-deal coupons generate more actions than percent-off coupons—increasing the number of registered actions. In at least one of the various embodiments, the recommendation engine application may make such determinations based on comparing the performance of one or more campaigns.

In at least one of the various embodiments, based on the identification of better performing campaigns for similarly situated merchants, the recommendation engine may determine one or more recommendations for campaign improvement. The particular recommendations for improvement (e.g., adding video, altering the coupon type, offering more coupons, or the like) may be determined based on observation of the performance of other merchants and campaigns.

A block 810, in at least one of the various embodiments, score information for the merchant may be generated based on the performance information for the merchant. In at least one of the various embodiments, the performance information may be distilled into one or more score information that may include values representing the overall performance of the campaign. In at least one of the various embodiments, the score information may include values may be counts of actions or views. Also, in at least one of the various embodiments, score information may include score values that may be computed. Score values may be generated to include the weighting that is described in block 806. Next, in at least one of the various embodiments, control may be returned to a calling process.

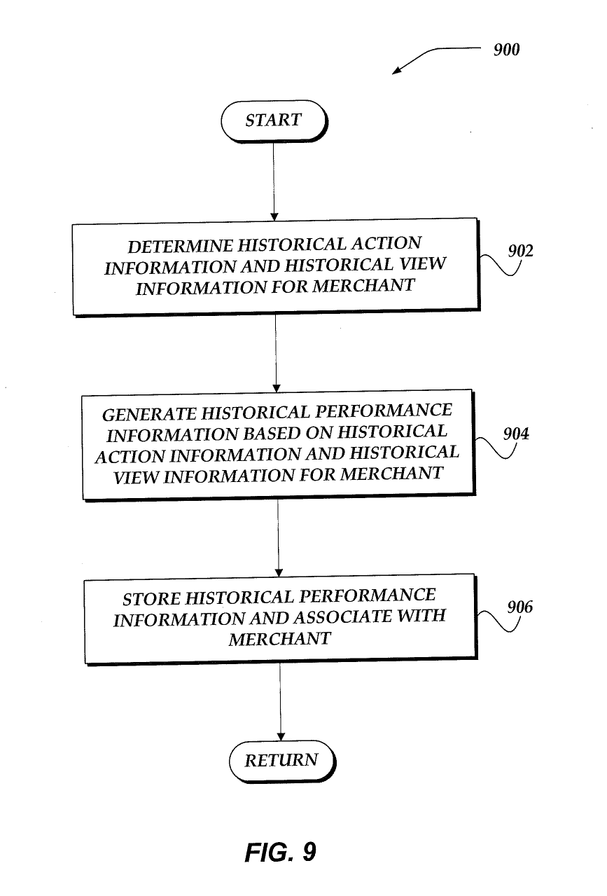

FIG. 9 illustrates a flowchart for process 900 for determining historical performance history for merchant campaigns in accordance with at least one of the various embodiments. After a start block, at block 902, in at least one of the various embodiments, historical action information and historical view information may be determined for a merchant and/or merchant campaign. In at least one of the various embodiments, a time range may be provided based on a configuration value and/or user input. The time range may be employed to determine the range of past action information and/or view information. For example, in at least one of the various embodiments, the time range may be determined to be the previous twelve months of action information.

At block 904, in at least one of the various embodiments, historical performance information may be generated based on the determined historical action information and/or the historical view information for a merchant and/or merchant campaign. In at least one of the various embodiments, historical performance information may be generated similarly to performance information (See, FIG. 8). In at least one of the various embodiments, previously generated performance information that corresponds to the time range of interest may be retrieved from a databases or other similar data store.

In at least one of the various embodiments, the historical performance information may include information, such as, moving averages (e.g. 3-day, 7-day, 30-day, or the like), means, medians, or the like. For example, process 900 may be arranged to generate a monthly average count of actions occurring with the previous 12-months.

In at least one of the various embodiments, the historical performance information may enable the current campaign to be compared to its own past performance. In at least one of the various embodiments, performance information application 319 may be arranged to determine previous time ranges where performance characteristics for the campaign exceed and/or fall below one or more defined thresholds (e.g., outlier ranges). One or more of the outlier ranges may be employed by a recommendation engine, such as, recommendation engine 320, for determining recommendation for improving a campaign. For example, if three of the last twelve months of a campaign used video advertisements, and if these three months exceeded a defined performance threshold, the recommendation engine may use this information to recommend the a campaign use video advertisements.

At block 906, in at least one of the various embodiments, the historical performance information may be stored and/or associated with the merchant and/or the campaign. In at least one of the various embodiments, the historical performance information may be stored in database or other similar data store for access by other process or applications, such as, performance information application 319, recommendation engine 320, report generator 321, or the like. Next, in at least one of the various embodiments, control may be returned to a calling process.

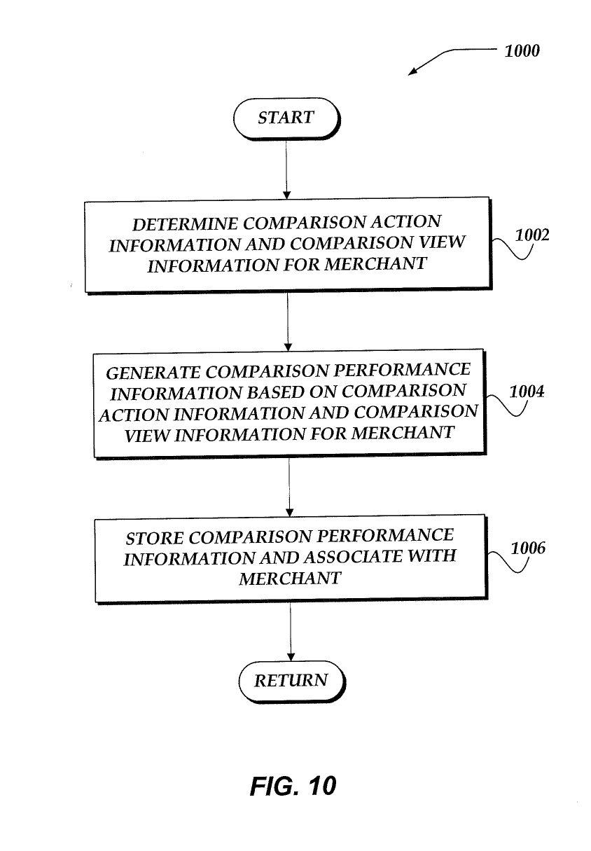

FIG. 10 illustrates a flowchart for process 1000 for determining comparison performance history for merchant campaigns in accordance with at least one of the various embodiments. After a start block, at block 1002, in at least one of the various embodiments, comparison action information and comparison view information may be determined for a merchant and/or merchant campaign. Similar to determining historical information as described for block 902, the action, comparison action information and/or comparison view information may be determined for a merchant and/or a campaign. However, in at least one of the various embodiments, comparison information may be determined from information, such as, action information, view information, performance information, or the like corresponding to other merchants.

In at least one of the various embodiments, the particular time range of the comparison information may be determined based on a predefined configuration value and/or user input. For example, the default time range as defined in a configuration file may be the previous 90 days of information. However, for example, a user may employ a user-interface to input values that override the default values to reduce or increase the time range.

In at least one of the various embodiments, comparison information may be information corresponding to merchant and/or campaigns that may include one or more similar characteristics. The merchant/campaign characteristics used as criteria for determining comparison merchant/campaigns may be determined using default values from a configuration file, user input, or the like, or combination thereof. In at least one of the various embodiments, comparison merchants may be determined based on characteristics, such as, merchant type, merchant size, market size, location information, or the like. Further, in at least one of the various embodiments, characteristics of the campaigns, such as, size of advertisements, coupons, coupon types, video enabled advertisements, markets, locations, or the like, may be used for selecting comparison merchants. For example, in at least one of the various embodiments, if the current merchant is a suburban dry cleaner, comparison merchants may include other dry cleaners located into suburban areas.

In at least one of the various embodiments, if an insufficient number of comparison merchants may be determined, the performance information application may be arranged to modify the criteria to be more inclusive. For example, if the comparison criteria is defined to require the same merchant type in the same metropolitan area (e.g., organic bakeries in Seattle) determines less than a predefined threshold of organic bakeries in Seattle the comparison criteria may be modified to “bakeries in Seattle” or alternatively “organic bakeries in Western Washington (a larger geographic region than just Seattle)”,” or the like. In at least one of the various embodiments, threshold values for quantity of comparators may be determined from a configuration file, user input, or the like. Likewise, in at least one of the various embodiments, comparison criteria may be determined from a configuration file, user input, or the like.

At block 1004, in at least one of the various embodiments, comparison performance information may be generated based on the determined comparison action information and/or the comparison view information for a merchant and/or merchant campaign. Comparison performance information may be determined similar to historical performance information as describe for block 904.

At block 1006, in at least one of the various embodiments, the comparison performance information may be stored and/or associated with the merchant and/or the merchant campaign. Comparison performance information may be stored similar to historical performance information as described for block 906. Next, in at least one of the various embodiments, control may be returned to a calling process.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system or even a group of multiple computer systems. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems, which perform the specified actions or steps, or combinations of special purpose hardware and computer instructions. The foregoing example should not be construed as limiting and/or exhaustive, but rather, an illustrative use case to show an implementation of at least one of the various embodiments of the invention.

### Illustrative User Interface Use Cases

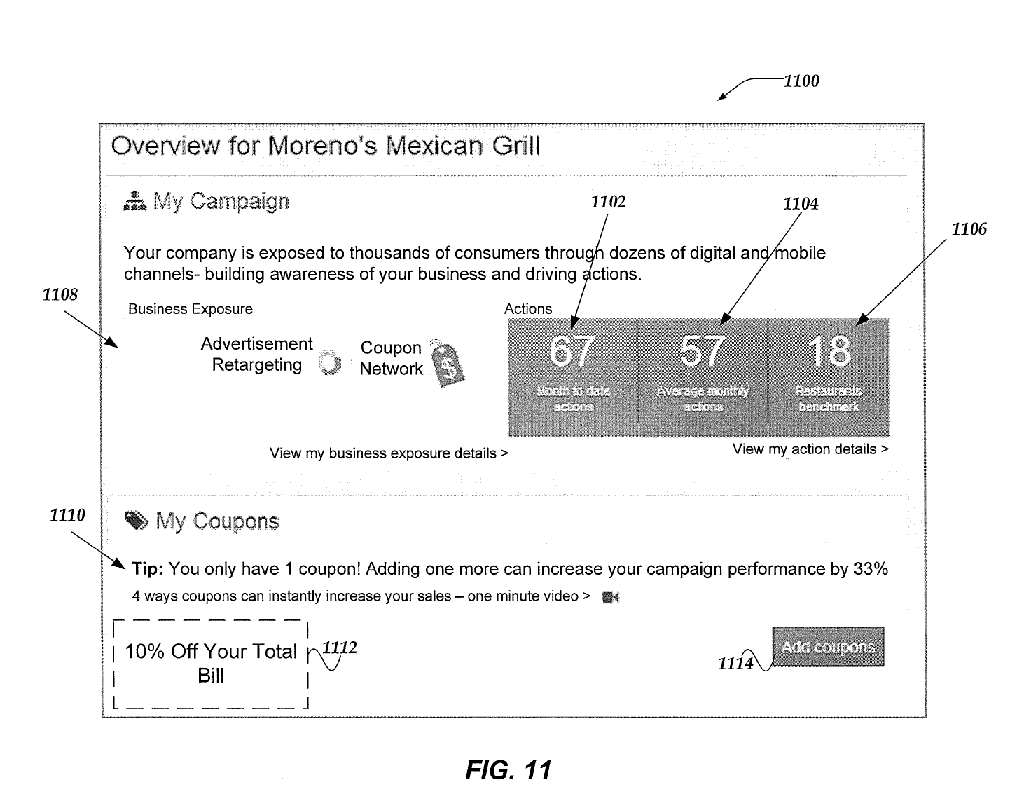

FIGS. 11-14 represent graphical user interfaces for multi-source performance and exposure for analytics in accordance with at least one of the various embodiments. In at least one of the various embodiments, user interfaces other than user interfaces 1100, 1200, 1300, or 1400 may be employed without departing from the spirit and/or scope of the claimed subject matter. Such user interfaces may have more or fewer user interface elements which may be arranged in various ways. In some embodiments, user interfaces may be generated using web pages, mobile applications, emails, PDF documents, text messages, or the like. In at least one of the various embodiments, content management application 316, performance information application 319, recommendation engine 320, report generator 321, or the like, may include processes and/or API's for generating user interfaces, such as, user interfaces 1100, 1200, 1300, or 1400.

FIG. 11 shows user interface 1100 for displaying an overview of the performance and exposure for the merchant's campaign in accordance with at least one of the various embodiments. In at least one of the various embodiments, actions scores that may be generated based on performance information, historical information, or comparison information may be displayed to a user (merchant). For example, action score 1102 represent the number of actions for the current month; actions score 1104 shows the average monthly actions for this campaign; and action score 1106 shows a benchmark value based on the comparison performance information. Further, in some embodiments, business exposure 1108 indicates which distribution programs/networks may be in use for this campaign. In this non-limiting example, business exposure 1108 indicates that this current campaign in participation in two distribution programs, Advertisement Retargeting and Coupon Network.

In at least one of the various embodiments, one or more recommendations, such as, recommendation 1110 may be displayed on user interface 1100. In this example, recommendation 1110 includes a recommendation that the campaign may be improved if more coupons are added to the campaign. In this non-limiting example, one or more recommendations, such as, recommendation 1110, may be displayed. In at least one of the various embodiments, such recommendations may be generated by recommendation engine 320, or the like.

In at least one of the various embodiments, one or more coupons, such as, coupon 1112 may be displayed to indicate the current coupons to the merchant. Further, in at least one of the various embodiments, button 1114 may be presented to enable a merchant user to navigate to coupon administration page/application (not shown) for modifying and/or adding coupons. Further, in at least one of the various embodiments, user interface 1100 may be arranged such that hovering over or clicking on a UI element may provide the merchant more details or link to pop-up UI regions or Web pages that provide additional details of specific elements. For example, hovering over coupon 1112 may cause the display of a popup window, tool-tip, or the like, that includes additional details about coupon 1112, such as, its past performance, age, number of other merchants using the same type of coupon, comparison information, performance information, or the like.

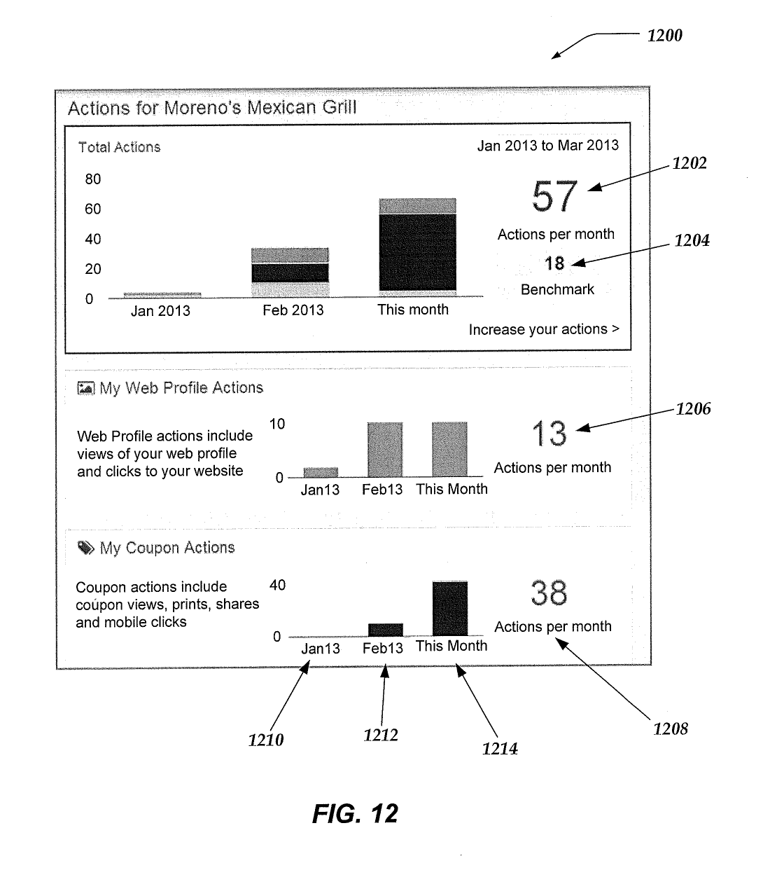

FIG. 12 shows user interface 1200 for displaying information about the actions associated with a campaign in accordance with at least one of the various embodiments. In at least one of the various embodiments, actions 1202 may be displayed along with benchmark information for comparison, such as, benchmark 1204. Furthermore, actions 1202 may be arranged to be an action score that represents the total number of actions per month for the campaign as a whole. In contrast, in at least one of the various embodiments, actions 1206, actions 1208, or the like, may be arranged to represent action scores for particular portions of a campaign. For example, actions 1206 may represent actions that correspond to a merchant's Web Profile. And, for example, actions 1208 may be arranged to represent actions corresponding to coupons. Further, though not shown in FIG. 12, there may be additional sections in user interface 1200 for other parts of a campaign, such as, videos, banner advertisements, classified advertisements, mobile advertisements, email advertisements, or the like, or combination thereof.

In at least one of the various embodiments, in addition to numerical representations of action scores, sections of user interface 1200 may include graphical representations corresponding to the action scores. For example, user interface 1200 includes bar charts representing the action scores for different time periods. For example, chart column 1210 represents action scores for the month that is two months previous to the current month, chart column 1212 represents the action scores for the previous month, and chart column 1214 graphically represents the action scores for the current month. Similarly, in at least one of the various embodiments, other, sections of user interface may also employ graphs and charts to represent the action scores. Also, though not shown, in at least one of the various embodiments, each section of user interface 1200 may be configured to represent action score using other well-known graphical methods. Accordingly, embodiments are not limited to the one representation shown in FIG. 12.

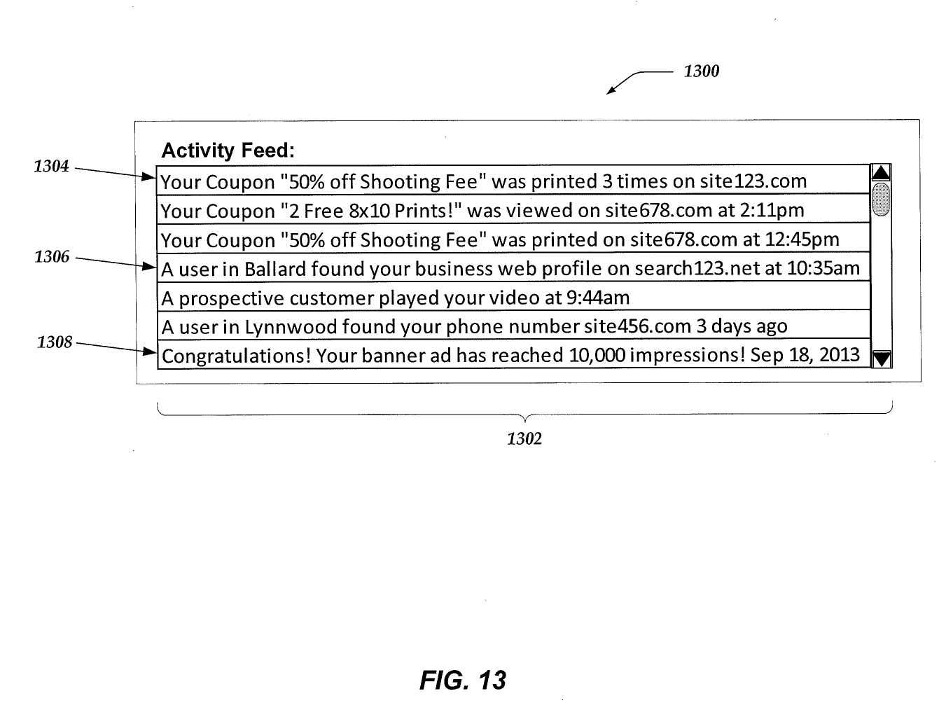

FIG. 13 shows user interface 1300 for displaying an activity feed that displays action events, view events, performance information, activities, or the like, that may be associated with a merchant and/or campaign in accordance with at least one of the various embodiments. In at least one of the various embodiments, list 1302 may include a scrollable list of activity records reflecting various events (e.g., actions, views, or the like) that may be associated with a campaign. For example, activity record 1304 reports that a particular coupon was printed three times from a particular website. Likewise, for example, activity record 1306 reports that a user located in the neighborhood of Ballard viewed and/or accessed the merchant's web profile at 10:35 am. Also, in at least one of the various embodiments, status updates, such as, activity record 1308 may be viewed in the user interface 1300 as well.

In at least one of the various embodiments, a user may select (e.g., click-on) an activity record to display additional details and/or context associated with the activity record. Further, a user may be enabled to configure how activity records are displayed. For example, one or more filters may be activated to exclude and/or hide particular types of activity records from display. Also, for example, sorting rules may be defined to emphasize and/or sort activity records. In at least one of the various embodiments, user interface 1300 may be included as a component in another user interface, such as a merchant administrative dashboard or the like.

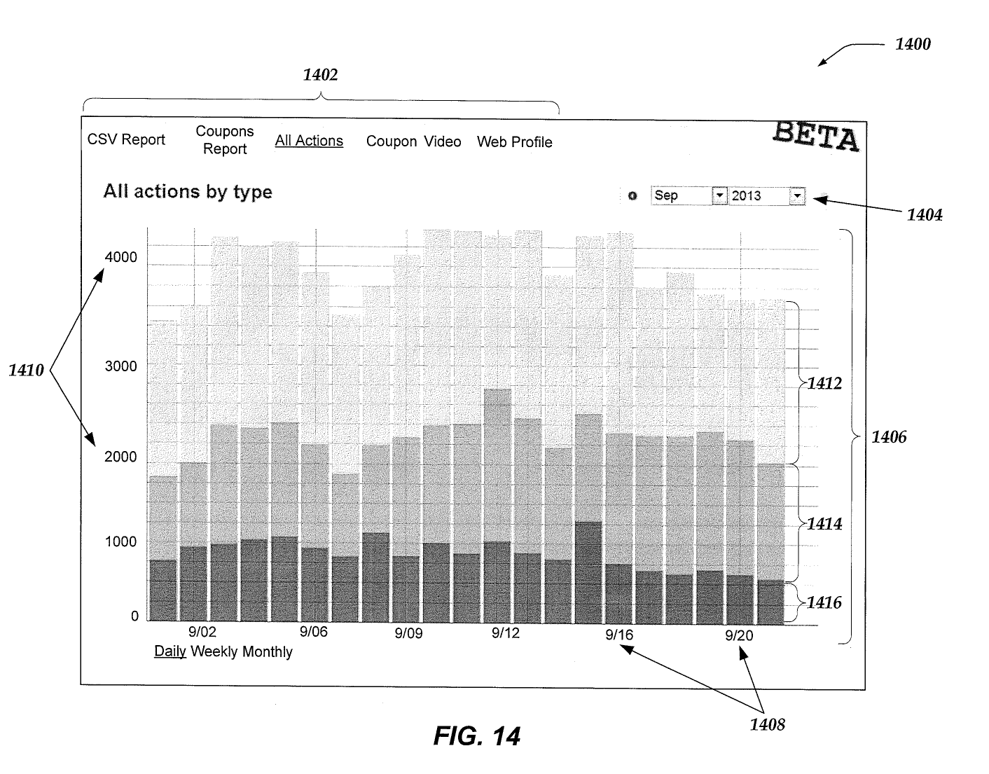

FIG. 14 shows user interface 1400 for displaying one or more administrative reports for multi-source performance and exposure for analytics in accordance with at least one of the various embodiments. In addition to user interfaces for merchants and consumers applications may be arranged to generate user interface for the administration of the content management system as whole. For example, a user interface, such as user interface 1400 may include menu different reports, such as, menu 1402. In this example, menu 1402 is arranged to include links to access to one or more reports that may be available, such as, CSV (comma separate value) Report, Coupons Report, All Actions, Coupon (Actions), Video (Actions), Web Profile, or the like. In this example, a report for “All Actions” is active.

In at least one of the various embodiments, report views may include a user interface for selecting the date ranges interest, such as date picker 1404. In this example, date picker 1404 enables month and year to be selected. Further, in this example, chart 1406 represents the actions that may be included in this report. In this example, the date each chart column represents in shown on the horizontal axis using labels, such as labels 1408. And, in this example, the vertical axis values, in this case, action, are indicated with labels, such as, labels 1410.

1. A method to improve the performance of at least one network computer to manage online content over a network comprising:
a hardware processor device included with the at least one network computer that executes software code to perform actions, comprising:
determining a plurality of events corresponding to a user's interaction with the online content from data that is provided over the network by at least one of a plurality of remotely located event sources;
generating action information corresponding to at least one event that is mapped to at least one action event, wherein the at least one mapped action event corresponds to at least one promotional campaign corresponding to an entity associated with the user;
generating performance information of the at least one promotional campaign based on at least a portion of the action information;
determining comparison entities based on criteria that includes at least one characteristic that matches a characteristic of the entity;
when an amount of the comparison entities is less than a predefined threshold value, modifying the criteria to determine the comparison entities until the amount of the comparison entities exceeds the predefined threshold value;
generating comparison information based on at least other performance information generated and corresponding to one or more of the comparison entities, wherein the at least other performance information corresponds to at least one other promotional campaign corresponding to the one or more comparison entities;
generating recommendation information to update at least one promotional activity corresponding to the at least one promotional campaign, wherein the recommendation information is based on the performance information and the comparison information;
updating the at least one promotional activity corresponding to the promotional campaign based on at least the recommendation information; and
generating report information that is displayed to a user based on at least the performance information and the recommendation information.

2. The method of claim 1, further comprising, generating historical information based on previously generated performance information that corresponds to the at least one promotional campaign and the entity.

3. The method of claim 1, wherein generating performance information, further comprises, at least one of, modifying the performance information based on at least one weighting factor, aggregating the performance information based on the location of the entity, aggregating the performance information based on the location of a consumer, or aggregating the performance information based on the category of the entity.

4. The method of claim 1, further comprising, determining view information based on mapping at least one other event to at least one view event, wherein the at least one event corresponds to at least one promotional campaign corresponding to the entity.

5. The method of claim 1, wherein generating action information corresponding to the at least one event that is mapped to at least one action event, further comprises, determining an action type that corresponds to the at least one event based in part on at least one event source wherein the at least one event source corresponds to the at least one event.

6. The method of claim 1, further comprising, generating score information corresponding to the at least one promotional campaign based on the performance information, wherein the score information includes at least a single value that represents a number of action events that correspond to the at least one promotional campaign.

7. The method of claim 1, further comprising, generating an activity feed that displays performance information that corresponds to the at least one promotional campaign.

8. The method of claim 1, further comprising, generating other report information that includes performance information from a plurality of promotional campaigns corresponding to a plurality of entities.

9. A system to improve the performance of at least one network computer to manage content over a network, comprising:
a network computer, including:
a transceiver that communicates over the network;
a memory that stores at least instructions;
a processor device that executes software instructions that perform actions, including:
determining a plurality of events corresponding to a user's interaction with the online content from data that is provided over the network by at least one of a plurality of remotely located event sources;
generating action information corresponding to at least one event that is mapped to at least one action event, wherein the at least one mapped action event corresponds to at least one promotional campaign corresponding to an entity associated with the user;
generating performance information of the at least one promotional campaign based on at least a portion of the action information;
determining comparison entities based on criteria that includes at least one characteristic that matches a characteristic of the entity;
when an amount of the comparison entities is less than a predefined threshold value, modifying the criteria to determine the comparison entities until the amount of the comparison entities exceeds the predefined threshold value;
generating comparison information based on at least other performance information generated and corresponding to one or more of the comparison entities, wherein the at least other performance information corresponds to at least one other promotional campaign corresponding to the one or more comparison entities;
generating recommendation information to update at least one promotional activity corresponding to the at least one promotional campaign, wherein the recommendation information is based on the performance information and the comparison information;
updating the at least one promotional activity corresponding to the promotional campaign based on at least the recommendation information; and
generating report information that is displayed to a user based on at least the performance information and the recommendation information; and
a client computer, including:
a transceiver that communicates over the network;
a memory that stores at least instructions;
a processor device that executes software instructions that perform actions, including:
receiving the report information; and
displaying a dashboard that includes at least a portion of the report information that is provided by the network computer.

10. The system of claim 9, further comprising, generating historical information based on previously generated performance information that corresponds to the at least one promotional campaign and the entity.

11. The system of claim 9, wherein generating performance information, further comprises, at least one of, modifying the performance information based on at least one weighting factor, aggregating the performance information based on the location of the entity, aggregating the performance information based on the location of a consumer, or aggregating the performance information based on the category of the entity.

12. The system of claim 9, further comprising, determining view information based on mapping at least one other event to at least one view event, wherein the at least one event corresponds to at least one promotional campaign corresponding to the entity.

13. The system of claim 9, wherein generating action information corresponding to at least one event that is mapped to at least one action event, further comprises, determining an action type that corresponds to the at least one event based in part on at least one event source wherein the at least one event source corresponds to the at least one event.

14. The system of claim 9, further comprising, generating score information corresponding to the at least one promotional campaign based on the performance information, wherein the score information includes at least a single value that represents a number of action events that correspond to the at least one promotional campaign.

15. The system of claim 9, further comprising, generating an activity feed that displays performance information that corresponds to the at least one promotional campaign.

16. The system of claim 9, further comprising, generating other report information that includes performance information from a plurality of promotional campaigns corresponding to a plurality of entities.

17. A processor readable non-transitory storage media that includes software instructions to improve the performance of at least one network computer to manage online content over a network, wherein the network computer that executes at least a portion of the software instructions performs actions, comprising:
determining a plurality of events corresponding to a user's interaction with the online content from data that is provided over the network by at least one of a plurality of remotely located event sources;
generating action information corresponding to at least one event that is mapped to at least one action event, wherein the at least one mapped action event corresponds to at least one promotional campaign corresponding to an entity associated with the user;
generating performance information of the at least one promotional campaign based on at least a portion of the action information;
determining comparison entities based on criteria that includes at least one characteristic that matches a characteristic of the entity;
when an amount of the comparison entities is less than a predefined threshold value, modifying the criteria to determine the comparison entities until the amount of the comparison entities exceeds the predefined threshold value;
generating comparison information based on at least other performance information generated and corresponding to one or more of the comparison entities, wherein the at least other performance information corresponds to at least one other promotional campaign corresponding to the one or more comparison entities;
generating recommendation information to update at least one promotional activity corresponding to the at least one promotional campaign, wherein the recommendation information is based on the performance information and the comparison information;
updating the at least one promotional activity corresponding to the promotional campaign based on at least the recommendation information; and
generating report information that is displayed to a user based on at least the performance information and the recommendation information.

18. The media of claim 17, further comprising, generating historical information based on previously generated performance information that corresponds to the at least one promotional campaign and the entity.

19. The media of claim 17, wherein generating performance information, further comprises, modifying the performance information based on at least one weighting factor, aggregating the performance information based on the location of the entity, aggregating the performance information based on the location of a consumer, or aggregating the performance information based on the category of the entity.

20. The media of claim 17, further comprising, determining view information based on mapping at least one other event to at least one view event, wherein the at least one event corresponds to at least one promotional campaign corresponding to the entity.

21. The media of claim 17, wherein generating action information corresponding to at least one event that is mapped to at least one action event, further comprises, determining an action type that corresponds to the at least one event based in part on at least one event source wherein the at least one event source corresponds to the at least one event.

22. The media of claim 17, further comprising, generating score information corresponding to the at least one promotional campaign based on the performance information, wherein the score information includes at least a single value that represents a number of action events that correspond to the at least one promotional campaign.

23. The media of claim 17, further comprising, generating an activity feed that displays performance information that corresponds to the at least one promotional campaign.

24. A network computer to manage online content over a network, comprising:
a transceiver that communicates over the network;
a memory that stores at least instructions;
a processor device that executes software instructions that perform actions to improve the performance of managing online content over the network, including:
determining a plurality of events corresponding to a user's interaction with the online content from data that is provided over the network by at least one of a plurality of remotely located event sources;
generating action information corresponding to at least one event that is mapped to at least one action event, wherein the at least one mapped action event corresponds to at least one promotional campaign corresponding to an entity associated with the user;
generating performance information of the at least one promotional campaign based on at least a portion of the action information;
determining comparison entities based on criteria that includes at least one characteristic that matches a characteristic of the entity;
when an amount of the comparison entities is less than a predefined threshold value, modifying the criteria to determine the comparison entities until the amount of the comparison entities exceeds the predefined threshold value;
generating comparison information based on at least other performance information generated and corresponding to one or more of the comparison entities, wherein the at least other performance information corresponds to at least one other promotional campaign corresponding to the one or more comparison entities;
generating recommendation information to update at least one promotional activity corresponding to the at least one promotional campaign, wherein the recommendation information is based on the performance information and the comparison information;
updating the at least one promotional activity corresponding to the promotional campaign based on at least the recommendation information; and
generating report information that is displayed to a user based on at least the performance information and the recommendation information.

25. The network computer of claim 24, further comprising, generating historical information based on previously generated performance information that corresponds to the at least one promotional campaign and the entity.

26. The network computer of claim 24, wherein generating performance information, further comprises, modifying the performance information based on at least one weighting factor, aggregating the performance information based on the location of the entity, aggregating the performance information based on the location of a consumer, or aggregating the performance information based on the category of the entity.

27. The network computer of claim 24, further comprising, determining view information based on mapping at least one other event to at least one view event, wherein the at least one event corresponds to at least one promotional campaign corresponding to the entity.

28. The network computer of claim 24, wherein generating action information corresponding to at least one event that is mapped to at least one action event, further comprises, determining an action type that corresponds to the at least one event based in part on at least one event source wherein the at least one event source corresponds to the at least one event.

29. The network computer of claim 24, further comprising, generating score information corresponding to the at least one promotional campaign based on the performance information, wherein the score information includes at least a single value that represents a number of action events that correspond to the at least one promotional campaign.

30. The network computer of claim 24, further comprising, generating other report information that includes performance information from a plurality of promotional campaigns corresponding to a plurality of entities.
